(19) United States
(12) Patent Application Publication
(10) Pub. No.: US 2023/0222945 A1
(43) Pub. Date: Jul. 13, 2023

(54) MULTISKILL EXERCISE FOR LAPAROSCOPIC INSTRUMENTATION

(71) Applicant: Applied Medical Resources Corporation, Rancho Santa Margarita, CA (US)

(72) Inventors: Daiane Aizen Grill, Rancho Santa Margarita, CA (US); Gregory K. Hofstetter, Rancho Santa Margarita, CA (US)

(21) Appl. No.: 18/094,624

(22) Filed: Jan. 9, 2023

Related U.S. Application Data
(60) Provisional application No. 63/297,408, filed on Jan. 7, 2022.

(51) Int. Cl. G09B 23/34; G09B 23/32

(52) U.S. Cl. CPC G09B 23/34; G09B 23/32

(57) ABSTRACT

A surgical training model for teaching, practicing, and assessing motor and cognitive skills associated with laparoscopic surgery is provided. The surgical training model has at least a portion (e.g., limbs) that is manipulatable by a user in order to maneuver those portions in a desired manner in order to interact with other portions of the surgical training model. Force perception mechanisms can also be included to inform a user when an applied force on one or more portions of the surgical training model is over a pre-determined amount.

This application claims priority to and benefit of U.S. Provisional Patent Application Ser. No. 63/297,408 entitled “Multiskill Exercise for Laparoscopic Instrumentation” filed on Jan. 7, 2022, which is incorporated herein by reference in its entirety.

### FIELD OF INVENTION

The present application generally relates to surgical training systems, and, more particularly, to surgical training systems for teaching, practicing, and assessing motor and cognitive skills associated with laparoscopic surgery.

### BACKGROUND OF INVENTION

A variety of challenges arise when a user (e.g., surgeon) performs laparoscopic surgery relying on indirect visualization (e.g., captured images) obtained from within a patient via a laparoscopic camera. Some challenges associated with the use of indirect visualization may include, but are not limited, to the user's hand-eye coordination and the user's awareness of how to maneuver the laparoscopic instrument(s) being used during the laparoscopic procedure. Furthermore, in some laparoscopic procedures, the user may be challenged to perform the motor-related tasks using both hands simultaneously. Thus, there is a need for a surgical training system that provides the requisite training to prepare users to perform the motor-related tasks using the indirect visualization associated with laparoscopic surgery.

### SUMMARY OF THE INVENTION

In accordance with various embodiments, a surgical training model is described herein. The surgical training model is made of a body having one or more holes positioned at pre-determined locations on the body. The model also includes a post that has a proximal end and a distal end. The proximal end of the post is attached to the body while the distal end extends away from the body. The model is made so that a user manipulate, using one hand, a portion of the body with a first surgical instrument while manipulating the post using the other hand via a second surgical instrument. The model aims to provide training for a user to use both hands simultaneously. At least in the embodiment of the model described above, the user is directed to thread the distal end of the post through the one or more holes associated with the body.

In accordance with various embodiments, another surgical training model is described. The surgical training model has a body with two or more holes at pre-determined locations on the body and a post that is attached to the body and extends away from the body. With respect to the two or more holes, the holes are configured to be positioned by a user in order to form a consolidated opening. The consolidated opening is then used as a point through which the user would thread the distal end of the post therethrough.

In accordance with various embodiments, another surgical training model is described. The surgical training model has a plurality of limbs, each having a proximal end and a distal end. The plurality of limbs are layered on top of each other at their proximal end. The plurality of limbs also each have one or more holes. The surgical model also has a post that is attached to the proximal ends of the plurality of limbs with a distal end that extends away from the plurality of limbs. A user is directed to manipulate one or more of the limbs so that the one or more holes associated with each of the plurality of limbs can be positioned so that the distal end of the post can be threaded therethrough.

In accordance with various embodiments, another surgical training model is described. The surgical training model has a body that has at least one connector at a first predetermined location and a corresponding connector at a second predetermined location. The surgical training model is designed for a user to manipulate the body in order to connect these two connectors together.

In accordance with various embodiments, another surgical training model is described. The surgical training model has a body made of a plurality of limbs each having a proximal end and a distal end that extends away from a center of the body. Each of the plurality of limbs have a connector at the distal end of the limb. At the center of the body is another connector. Each of the limbs of the body is configured to be manipulated so that one of the connectors associated with a limb can be connected to the connector at the center of the body.

In accordance with various embodiments, a method for training is described. The method includes the step of providing a model such as using one of the models described above. The model may have a body with one or more holes and a post. The model is designed so that a user uses one surgical instrument to manipulate a portion of the body and another surgical instrument to manipulate a portion of the post to thread a distal end of the post through one or more of the holes in the body.

In accordance with various embodiments, a method for training is described. The method includes the step of providing a model such as using one of the models described above. The model may have a body with two or more bodies. The model is designed so that a user uses one surgical instrument to manipulate a portion of the body with a first connector and another surgical instrument to manipulate a different portion of the body with a second connector to connector the two connectors.

### BRIEF DESCRIPTION OF THE DRAWINGS

The present inventions may be understood by reference to the following description, taken in connection with the accompanying drawings in which the reference numerals designate like parts throughout the figures thereof.

FIG. 1 is an exemplary multiskill exercise model.

FIG. 2 is an exemplary multiskill exercise model similar to FIG. 1 with emphasis towards the one or more elongate portions and force perception mechanisms implemented therein.

FIG. 3 is an exemplary multiskill exercise model having a working plane.

FIG. 4A and FIG. 4B illustrates an exemplary laparoscopic training task.

FIG. 5A-FIG. 5D illustrates steps associated with an exemplary laparoscopic training task.

FIG. 6A and FIG. 6B illustrate how to complete an exemplary laparoscopic training task.

FIG. 7 illustrates various planes associated with an exemplary multiskill exercise model.

FIG. 8A and FIG. 8B illustrate a user interacting with the post and/or limb of an exemplary multiskill exercise model.

FIG. 9A-FIG. 9C illustrate an embodiment of a force perception mechanism associated with an embodiment of the multiskill exercise model.

FIG. 10A and FIG. 10B illustrate exemplary support structures and materials incorporated with the body near the axis of symmetry.

FIG. 11A-FIG. 20 are exemplary embodiments of multiskill exercise models.

FIG. 21-FIG. 23 illustrate an exemplary surgical trainer and exemplary embodiments of the multiskill exercise model therein.

### DETAILED DESCRIPTION

In accordance with various embodiments, a surgical training system is provided, and various views of various embodiments of exemplary surgical training systems and aspects thereof are shown in the figures. One such surgical training system includes a surgical training model that is compatible with a laparoscopic trainer system to facilitate a user's development of necessary motor and cognitive skills used during laparoscopic surgery. For example, exemplary motor and cognitive skills may include but are not limited to simultaneous active use of both hands, bimanual dexterity, hand-eye coordination, depth perception, instrument motion/rotation, and force perception. Users for the surgical training system described herein may both include novice users such as residents or students as well as more experienced users such as practicing surgeons.

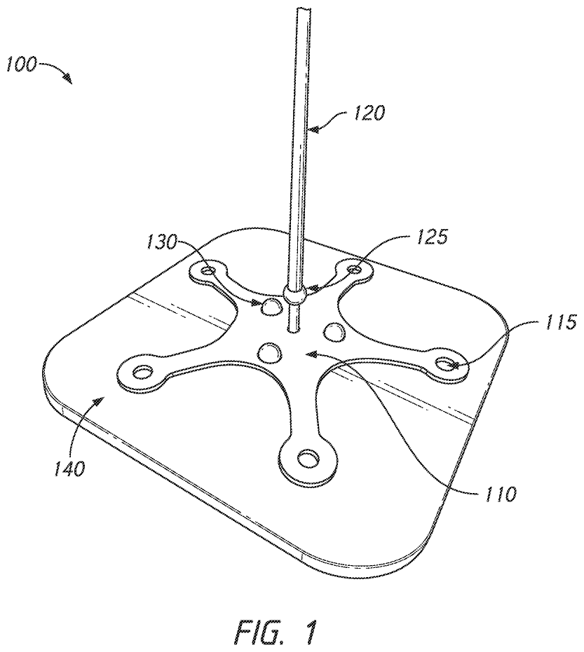

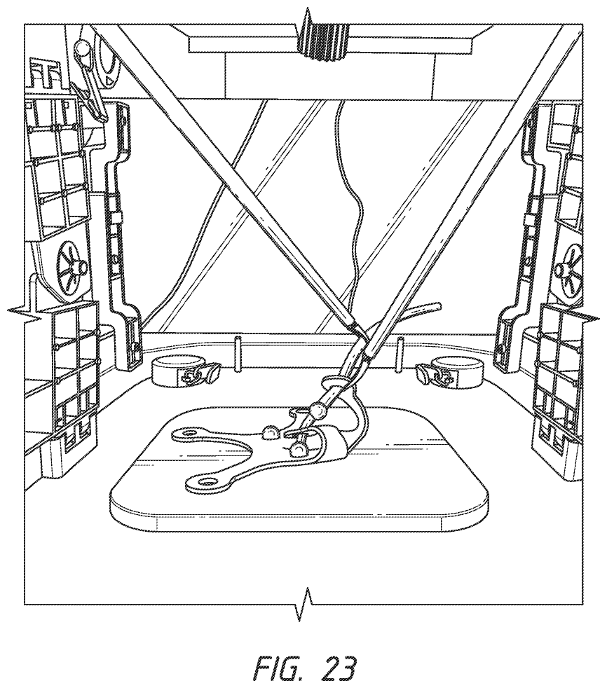

FIG. 1 illustrates an exemplary embodiment of a surgical training model designed to develop motor and cognitive skills used during laparoscopic surgery (hereinafter referred to as a multiskill exercise model 100). In some embodiments, the multiskill exercise model 100 is configured to be compatible with and received by a laparoscopic trainer 2100. An exemplary laparoscopic trainer 2100 is illustrated in FIG. 21. The laparoscopic trainer 2100 is configured to simulate laparoscopic conditions that the user may encounter during a laparoscopic procedure. FIG. 23 illustrates an embodiment where the multiskill exercise model 100 is being used while within the laparoscopic trainer 2100.

Returning back to FIG. 1, the exemplary multiskill exercise model 100 comprises at least four different elements designed to interact with each other to facilitate the development of a user's motor and cognitive skills. These four elements are the body 110, the post 120, components (e.g., pegs 130) associated with a force perception mechanism, and the base 140. Further details regarding each of these four elements will be provided below. However, it should be noted that other embodiments of the multiskill exercise model 100 (some of them being discussed below) are contemplated which may include less than these four highlighted elements. In addition, other embodiments of the multiskill exercise model 100 may also have different versions of the same elements (e.g., having different configurations, shapes) than those illustrated in FIG. 1. In any case, these other embodiments of the multiskill exercise model 100 provide different ways in which the described surgical training system can facilitate in the development of the motor and cognitive skills of the user associated with surgery, in particular, laparoscopic surgery.

With continued reference to FIG. 1, example embodiments include the body 110. The body may be designed to be generally planar. The body 110 can have a thickness ranging from between 0.05 inches to 0.1 inch. In various embodiments, the thickness of the body 110 can be uniform. In other embodiments, the thickness of the body 110 at the center can be different from the thickness of the body 110 at the outermost portions. For example, the center of the body 110 may have a thickness of 0.1 inch and gradually becomes thinner towards the outermost portions of the body 110.

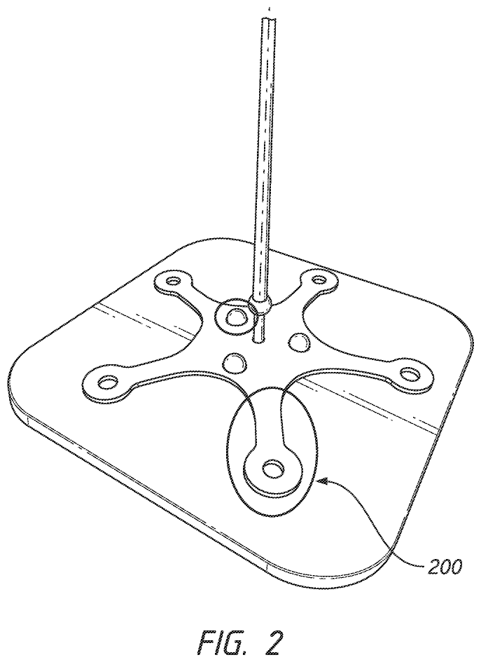

In some embodiments, the body 110 may be formed to have one or more elongate portions (herein referred to as limbs 200 as seen in FIG. 2) that extend away from a center of the body 110. Each of the limbs 200 may have the same configuration with respect to each other related to their width, length, and thickness. In various embodiments, each of the limbs 200 may also differ between each other with respect to one or more of their width, length, and/or thickness.

In various embodiments, the body 110 may have multiple different sets of openings. As illustrated in FIG. 1, there may be a first set of openings 115 at the end of each of the limbs 200 furthest away from the post 120. As illustrated in the figure, the first set of openings 115 may be located at pre-determined positions along each of the limbs 200, such as the distal ends of each of the limbs 200. In various embodiments, each limb 200 may have additional openings located along the length of the limb 200 at pre-determined locations. These additional openings may be on the same location on each limb 200. In various embodiments, these additional openings along the length of the limbs 200 may also be at varying locations across each of the different limbs 200.

The body also includes at least a second set of openings located near the center of the body 110 and near the post 120. As illustrated, the second set of openings are configured to interface with the components associated with implementing a force perception mechanism for the multiskill exercise model 100 (e.g., pegs 130). The force perception mechanism (implemented via the pegs 130) are designed to monitor and characterize an amount of force being applied to portions of the multiskill exercise model 100 (e.g., the body 110 and/or the post 120). In various embodiments, the second set of openings may be arranged at pre-determined locations on the body 110. In various embodiments, the second set of openings may be aligned with the first set of openings 115. In various embodiments, the second set of openings may be positioned offset from the first set of openings 115. Although FIG. 1 illustrates an exemplary number of first 115 and second set of openings, it is contemplated that other embodiments may have as many or as few openings associated with the first set of openings 115 and/or the second set of openings as desired. Furthermore, in various embodiments, the characteristics associated with the first set of openings 115 may be similar or the same as the openings associated with the second set of openings.

In various embodiments, the body 110 also includes at least one central opening for the post 120. In an embodiment, the central opening for the post 120 is located at a center of the body 110, the base 140, or both. This allows the post to be attached/anchored at some point beneath the base 110 and/or the base 140 and threaded through the body 110 and/or the base 140. In various embodiments, the post 120 can be located at a different location on the body 110, base 140, or both which is not at the center. A corresponding opening for the post 120 at one or more of the different locations can be provided as well. In various embodiments, the diameter of the central opening for the post 120 can range from 7/32 inches to 17/64 inches. The central opening for the post 120 would correspond to the diameter/cross-sectional area of the post 120. In various embodiments, the diameter/cross-sectional area of the central opening for the post 120 will be smaller than the diameter/cross-sectional area of the post 120 in order to provide for an interference-type connection.

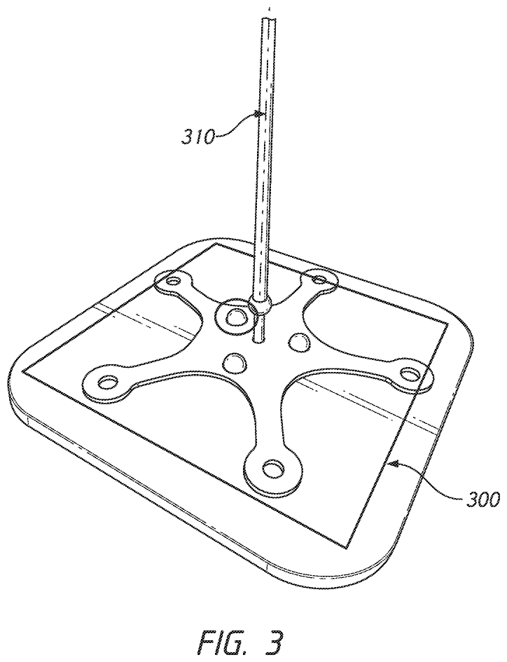

In various embodiments, the body 110 may be positioned on the base 140 which corresponds to a working plane 300. The working plane 300 is generally defined by the rectangular shape superimposed on the multiskill exercise model 100 in FIG. 3. In various embodiments, the body 110 and the base 140 may both be generally planar. In some embodiments, the body 110 and/or base 140 may not be planar, e.g., curved or contoured (e.g., following a contour of a simulated organ). In various embodiments, the base 140 is dimensioned to fit within a surgical trainer. For example, the base 140 can be 6 inches by 6 inches in size although other sizes are useable and have been contemplated.

In various embodiments, the body 110 is aligned/positioned to be axisymmetric with a symmetry axis 310 in a direction normal or traverse to the working plane 300 as illustrated in FIG. 3. In various embodiments, the post 120 can be placed at the symmetry axis 310. Other embodiments have been contemplated whereby the body 110 is not aligned/positioned in an axisymmetrical manner (e.g., off center relative to the base 140). Furthermore, the post 120 can be placed at different locations other than the symmetry axis 310 of the multiskill exercise model 100. Furthermore, other embodiments may be provided where multiple posts 120 are included in the multiskill exercise model 100 and thus arranged in various locations throughout (which may or may not include the symmetry axis).

Returning back to FIG. 1, in various embodiments, the base 140 has the second set of openings that are configured to receive one or more pegs 130. The pegs 130 are used to implement the force perception mechanism for the multiskill exercise model 100. Generally, the force perception mechanism provides a feature for the multiskill exercise model to notify to the user when an excessive amount of force has been detected when the user interacts with portions of the multiskill exercise model. The excessive amount of force corresponds to an amount of force which may cause trauma to tissue during an actual surgical procedure. Thus, it is desired to notify the user of the occurrence of the excessive amount of force. In various embodiments, the notification (via the force perception mechanism) that the user has exerted an excessive amount of force corresponds to the body 120 becoming detached from one or more of the pegs 130.

In accordance with various embodiments, the force perception mechanism using the pegs 130 illustrated in FIG. 1 can have the pegs 130 be inserted or adhered to the base 140. In various embodiments, the pegs 130 may be constructed with the base 140 (as a monolithic structure). In various embodiments, the pegs 130 can be used to implement the force perception mechanism though other structures are also possible, contemplated, and described herein. In addition, the structures used to implement the force perception mechanism can also vary, for example, in their shape or size. In various embodiments, the pegs 130 (as illustrated in FIG. 1) may generally be vertically extending away from the base 140 comprising a neck portion (having, for example, a nominal diameter of 5/16″) and a spherical top (or head) portion. The example peg 130 introduces resistance to a portion of the body 110 preventing the body 110 from detaching from the peg 130. In particular, the neck portion of peg 130 is configured to provide the main resistive force for the body 110. Generally the pegs 130 will have a diameter or cross-sectional area that is slightly larger than the diameter or cross-sectional area of the second set of openings that are adapted to receive the pegs 130.

Each of the pegs 130 used to implement the force perception mechanism for the multiskill exercise model illustrated in FIG. 1 are configured to interface with the body 110 through the second set of openings in the body 110 to provide a removable connection between the body 110 and the base 140. The removable connection formed between the body 110 and the pegs 130 is more specifically an interference-type fit which prevents the body 110 from becoming detached from the pegs 130 attached to the base 140 via resistive forces present between the body 110 and the pegs 130.

Although an exemplary embodiment of the peg 130 has been described above, various embodiments may utilize other forms of the pegs 130 each having a variety of different shapes and different sizes which provide different characteristics to the removable connection (e.g., interference-type fit) with the body 110. By changing aspects of the peg 130 and/or the body 110, the characteristics associated with the removable connection between the peg 130 and the body 110 can also be adjusted—namely affecting the difficulty or ease of how the body 110 is detachable from the peg 130. The force perception mechanism (implemented in this embodiment, for example, via the pegs 130) teaches users how to learn to control and manage an amount of force being exerted to portions of the multiskill exercise model 100 so as to minimize and prevent tissue trauma. A visual cue (e.g., detachment of the body 110 from the peg 130) is provided in order to notify the user when excessive force has been detected.

In various embodiments, a post 120 is positioned at the center of the multiskill exercise model 100. In various embodiments, the post 120 can have varying lengths but would need to be sufficiently long to allow for the first set of openings 115 associated with one or more limbs associated with the body 110 to interface with the post 120. However, the length of the post 120 should not be too long such that a tip of the post 120 exceeds the dimensions (e.g., height) of the surgical trainer or exceeding a frame view captured by a laparoscopic device/imaging device within the surgical trainer (e.g., 5″).

In various embodiments, the post 120 of the multiskill exercise model 100 is configured to be a solid (i.e., non-hollow) tubular structure. In various other embodiments the post 120 can be a tubular structure that is hollow. In various embodiments, the post 120 may be made of a material which is capable of being stretched along its length (e.g., along the symmetry axis as illustrated in FIG. 2). When in a state of rest (i.e., not stretched), the post 120 may at least partially collapse. When stretched, the post 120 can be held taut and directed to point in any number of different directions. Furthermore, in various embodiments, the post 120 is also capable of flexing in at least one direction.

In various embodiments, the post 120 may be flexible. In some embodiments, the post 120 of the multiskill exercise model 100 may be a solid or rigid rod that is not capable of flexing or stretching. In additional embodiments, the multiskill exercise model 100 may have a post 120 that is configured to have different shapes, cross-sections and/or have different configurations than those described herein. Furthermore, the post 120 of the multiskill exercise model 100 may have varying different degrees of stretchability or rigidness based on any combination of flexible and rigid materials which may be used to make the post 120. Various different types of posts 120 will be described below in connection with various different embodiments.

In various embodiments, the body 110 and/or the post 120 of the multiskill exercise model 100 being bendable provides interactivity between the body 110 and the post 120. In some embodiments, both the body 110 and the post 120 of the multiskill exercise model 100 may be made of various different types of elastomeric materials that allow both the body 110 and the post 120 to bend and flex thereby allowing interactivity between the body 110 and the post 120. The flexibility between the body 110 and the posts 120 allows the user to manipulate one or both the body 110 and the post 120 in different ways to develop the motor and cognitive skills associated with laparoscopic surgery in connection with performing a laparoscopic training task (as discussed below in further detail).

In some embodiments, the base 140 of the multiskill exercise model 100 may be made of a material that provides a rough surface that is in contact with the body 110. The rough surface associated with the base 140 can minimize/prevent interference of the body 110 by the base 140, e.g., a “stickiness” of contact between the body 110 and the base 140. In this manner, the connection between the body 110 and the base 140 may not influence the force perception mechanism where the “stickiness” could inadvertently add additional resistance that would prevent the body 110 from detaching from the pegs 130. However, in other embodiments, the base 140 of the multiskill exercise model 100 can also be made of the same or similar material as the body 110 and post 120. The use of materials that provide some inherent “stickiness” between the body 110 and the base 140 can introduce additional factors that affect (e.g., increase) the pre-determined force threshold associated with the force perception mechanism between the body 110 and the pegs 130.

In addition, other embodiments have been contemplated that can be used to prevent or reduce adherence or stickiness between the body 110 and the base 140. For example, the body 110 and/or the base 140 may have any number of surface features positioned on their respective surfaces to prevent or reduce adherence or stickiness. The surface features may also facilitate movement of portions of the body 110 away from a base 140. In various embodiments, an anti-stick coating or layer can also be attached or integrated with one or more of the body 110 and/or base 140 to prevent or reduce adherence or stickiness as well. In various embodiments where the multiskill exercise model 100 has a plurality of layered bodies 110, these surface features can also be used to minimize or prevent adherence or stickiness between adjacent layers of bodies 110 as well.

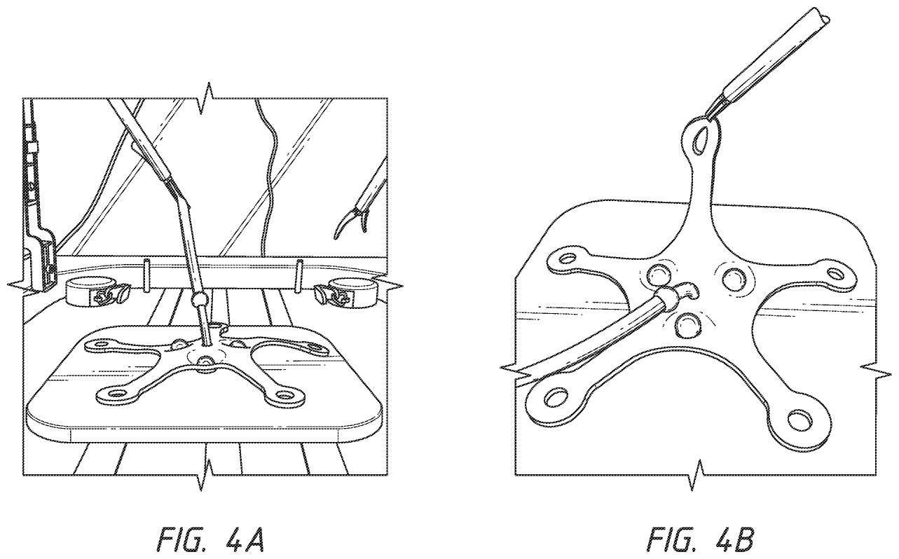

As seen in FIG. 4A and FIG. 4B, the user is able to manipulate the post (in FIG. 4A) and the one or more limbs (in FIG. 4B) while performing a laparoscopic training task. In various embodiments, the multiskill exercise model 100 is designed to have the user perform one or more different laparoscopic training tasks with the aim to develop the user's motor and cognitive skills that are applicable for laparoscopic surgery. One such laparoscopic training task is referred to as “Limbs in the Body.”

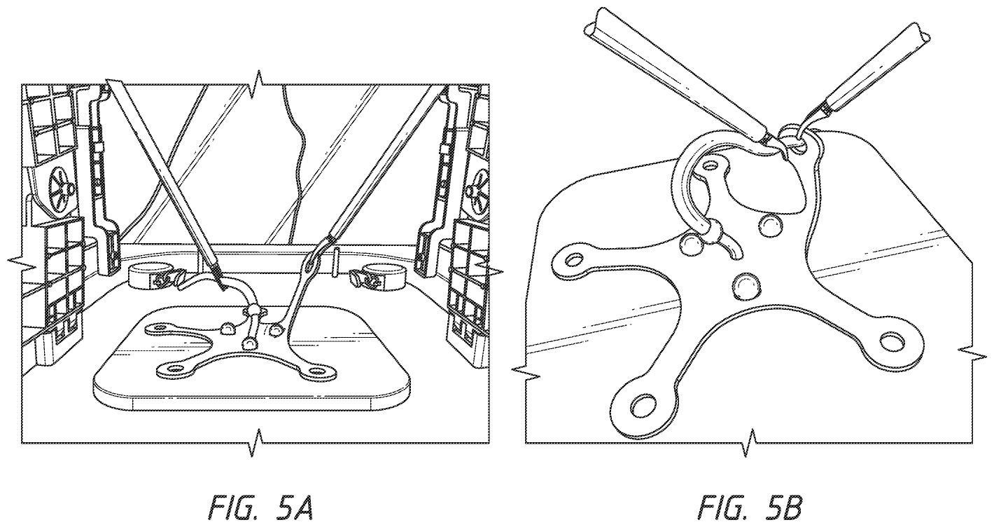

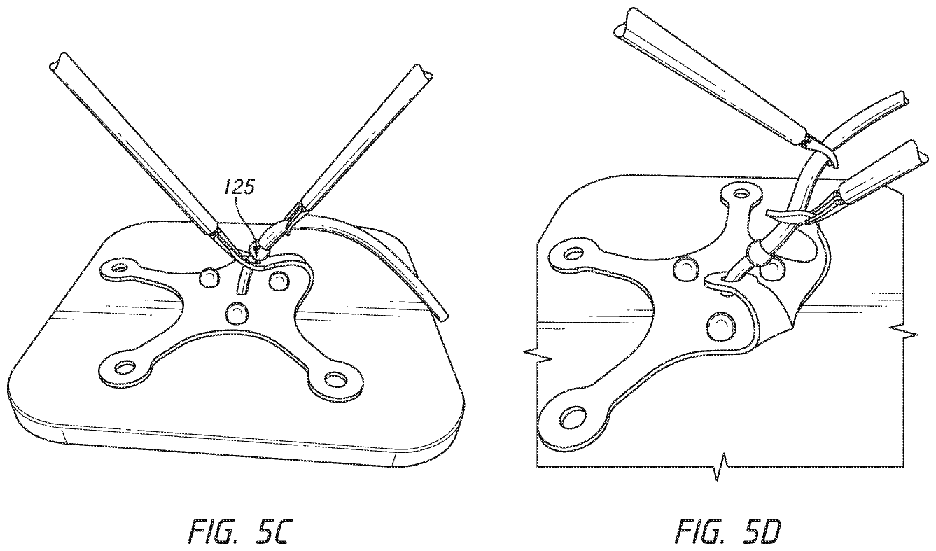

With reference to FIG. 5A-FIG. 5D, the figures illustrate steps associated with an exemplary laparoscopic training task (e.g., “Limbs in the Body”) that users can perform using the multiskill exercise model 100. In particular, the exemplary laparoscopic training task involves separate steps that the user would need to perform in order to complete the task.

An exemplary first step would have the user manipulate the post and one of the limbs simultaneously. In particular, the user would be using two different laparoscopic devices in order to control and maneuver the post and one of the limbs. For example, the user could use the left hand holding the left laparoscopic device to control the post (as seen in FIG. 4A) while the right hand holding the right laparoscopic device controls a limb (as seen in FIG. 4B). Both the post and limb can be controlled and maneuvered simultaneously (as seen in FIG. 5A).

As noted above, the multiskill exercise model 100 can be symmetric thereby allowing the user to swap between both hands in order to perform laparoscopic training tasks using the multiskill exercise model 100. In particular, in some tasks, the user may use their right hand to manage the post while the user's left hand maneuvers the limbs on the left side of the multiskill exercise model 100. In performing tasks involving limbs on the right side of the multiskill exercise model 100, the user may use their left hand to manage the post while the user's right hand maneuvers the limbs on the right side. The symmetric nature of the multiskill exercise model 100 (about the z axis) allows for similar (but opposite) laparoscopic training tasks to be performed using both of the user's hands. This provides the multiskill exercise model 100 the ability to be agnostic to a user's hand dominance. In other words, laparoscopic surgical tasks being performed on one side of the multiskill exercise model 100 using the user's hands in one set of roles will have a symmetric counterpart on the other side of the multiskill exercise model 100 that would utilize the user's hands in the opposite set of roles. In this way, the laparoscopic surgical tasks performed via the multiskill exercise model 100 facilitate in the development of bimanual dexterity.

As seen in FIG. 5B, the user would be directed to maneuver the opening of the limb with respect to the post. In particular, the user would maneuver the opening at the end of the limb such that the top of the post is able to thread through the opening in the limb. Afterwards, the user can maneuver the limb down the length of the post thereby completing the laparoscopic task for that limb as seen in FIG. 5C. In various embodiments, the opening of the limb may need to clear some obstacle (e.g., nob 125) indicating that the limb has been moved a sufficient distance down the post.

In various embodiments, the user may repeat this task with the other limbs as seen in FIG. 5D. With each of the different limbs surrounding the post, different challenges arise although the same steps of maneuvering the opening of the limb to the post remain. For example, the direction that the limb extends from the post can impact the user's depth perception. Furthermore, as more limbs are being connected to the post through their respective openings, there may be a lesser amount of force that may be allowed in the continued performance of the laparoscopic training task due to the added tension to the body. Any excessive force being applied by the user when interacting with later limbs can cause the body to disengage with one or more of the pegs.

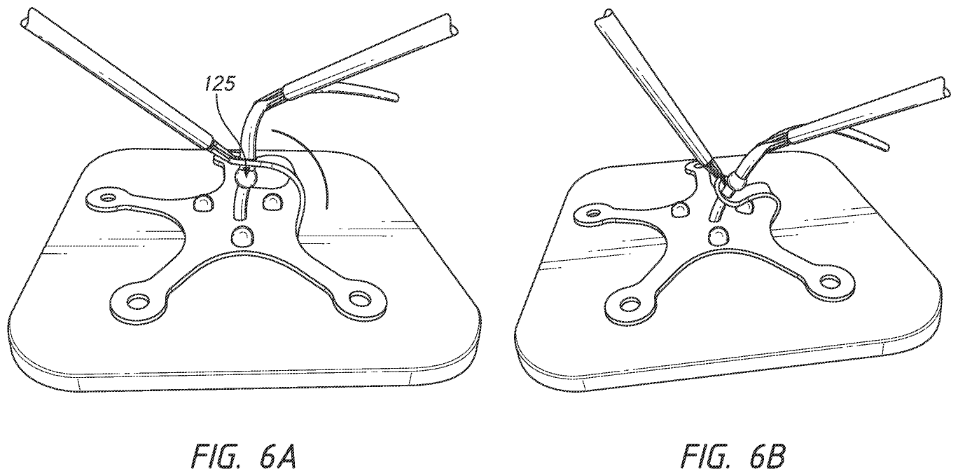

As noted above, the post 120 may have an obstacle 125 that can be used to indicate how far the user must lower the limb down the length of the post 120. An exemplary obstacle 125 is illustrated in FIG. 6A and FIG. 6B. An obstacle 125 (e.g., nob) may be an added feature to the post 120 where the obstacle 125 may consist of a portion of the post 120 which has a larger cross-sectional area than nearby portions of the post 120 and the opening 115 of the limb. In various embodiments, the obstacle 125 may have a variety of different sizes with respect to the opening 115 of the limb. If the size of the obstacle 125 is equal or larger than the opening 115 of the limb, force may be required by the user to have the opening 115 of the limb clear the obstacle 125 of the post 120.

When the obstacle 125 is present, the laparoscopic training task may require the user to have the opening of the limb clear the obstacle 125 (e.g., move the body 110 below the obstacle 125 along the post 120) to deem the laparoscopic training task complete. As illustrated in the figure, an example scenario is shown where the user has moved the opening 115 of the limb to a position above the obstacle 115 (see FIG. 6A). After the user exerts some amount of force on the limb, the opening 115 is able to clear the obstacle 125 such that the limb is positioned below the obstacle 125 on the post 120 (see FIG. 6B). The latter scenario corresponds to the user clearing/completing the laparoscopic training task for that limb. However, this act of clearing the obstacle 125 needs to be completed without exerting an excessive amount of force to the limb and/or the post 120 that could potentially cause the body 110 to become detached from one or more pegs 130.

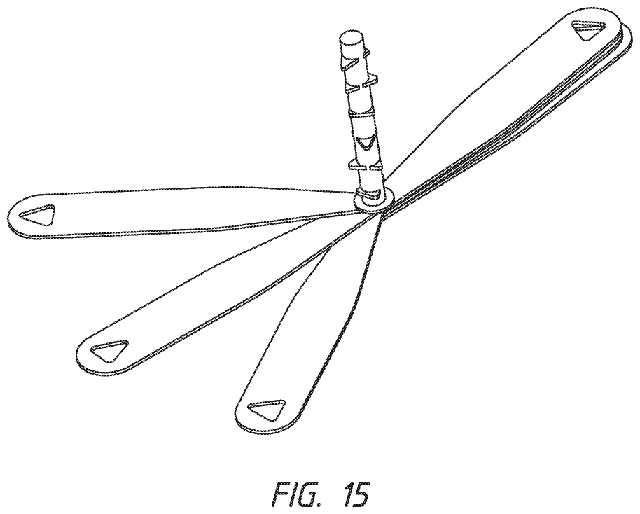

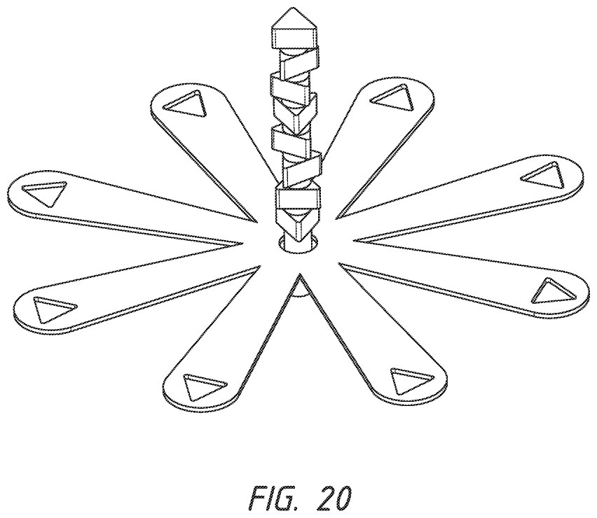

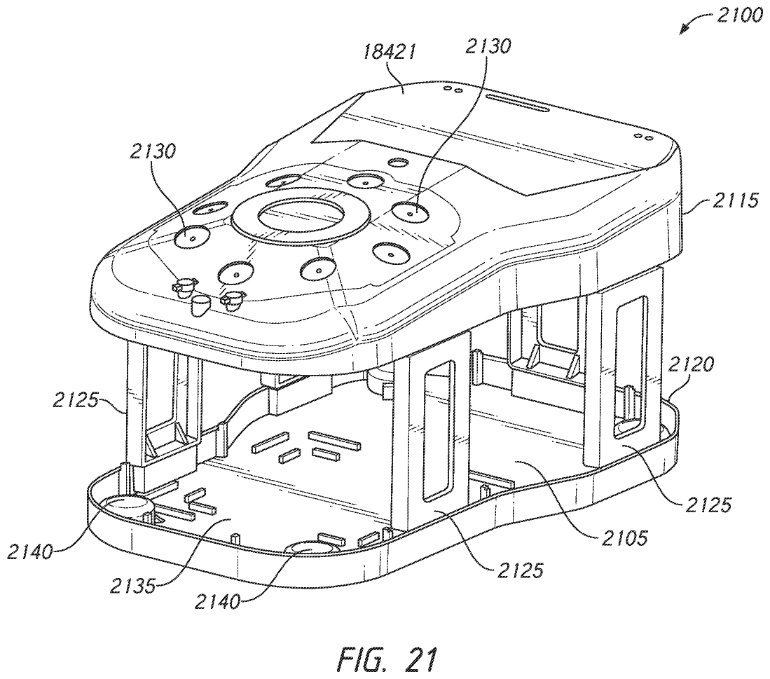

In various embodiments, the multiskill exercise model 100 may have the obstacle 125 of the post 120 have a variety of different cross-sectional shapes different from being circular/spherical in shape. Such exemplary embodiments are discussed below (see FIG. 15 and FIG. 20) with the cross-sectional shapes being different geometric shapes such as a triangle. In various embodiments, the openings 115 of the limbs would have similar cross-sectional shapes as the cross-sectional shape of the post and the obstacle so that the user is able to maneuver the opening of the limb down the length of the post and exert an amount of force on the limb to allow for the opening 115 of the limb to clear the obstacle 125.

In some embodiments, the force perception mechanism is incorporated with a multiskill exercise model to increase the difficulty in the completion of the laparoscopic training task by imposing a force requirement or force threshold. Because there may be a disconnect between the amount of force that the user exerts on a surgical device, e.g., a laparoscopic device, and the corresponding force that the surgical device in turn exerts on the tissue being operated on, the force perception mechanism is provided as a teaching means so users are able to learn and train on the application of force using the surgical devices with the multiskill exercise model 100.

In various embodiments, the force perception mechanism is configured to have pre-determined force thresholds corresponding to an allowable amount of force that may be exerted by the user during a laparoscopic procedure before the force perception mechanism notifies the user that an excessive amount of force was just used. In various embodiments, structures (e.g., pegs) that are used to implement the force perception mechanism may each have the same pre-determined force threshold. In various embodiments, subsets of the structures implementing the force perception mechanism may have different pre-determined force thresholds compared to other sets of structures.

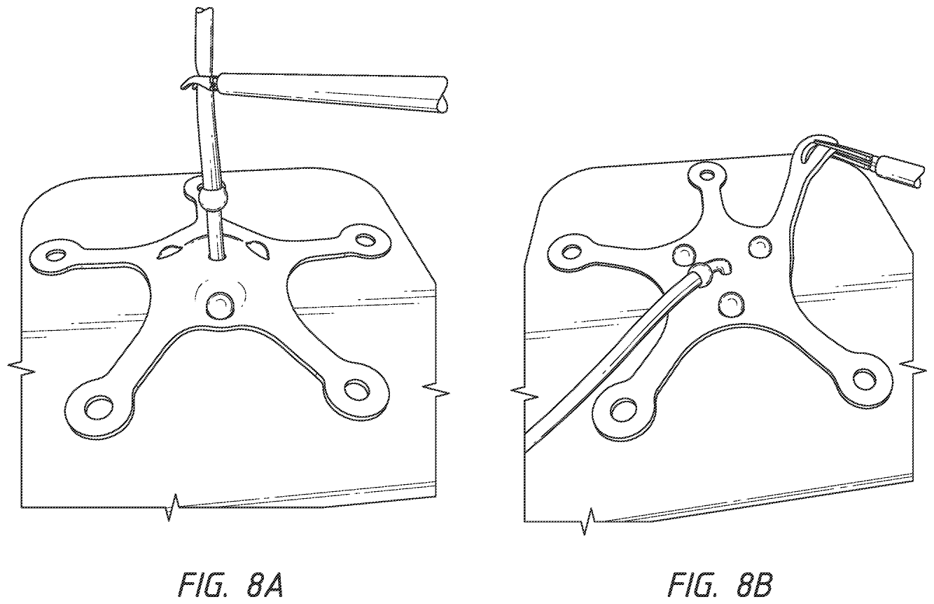

In various embodiments, the force perception mechanism is used to teach and train the user about the amount of force being transferred to the tissue via laparoscopic devices being used by the user. In various embodiments the laparoscopic training task may involve the user interacting with the post 120 (see FIG. 8A) and/or at least one of the limbs of the body 110 (see FIG. 8B). Interactions with each of these aspects of the multiskill exercise model 100 may cause portions of the body 110 to disengage from one or more structures (e.g., pegs 130) used to implement the force perception mechanism for the multiskill exercise model 100. With the force perception mechanism, users can be trained on how to minimize or manage the amount of force being exerted on the multiskill exercise model 100 during the laparoscopic training task (via the laparoscopic devices) so that the corresponding allowable amount of force being applied during an actual laparoscopic procedure does not cause trauma to tissue and/or organs. In many cases, the application of force that may cause trauma to tissue and/or organs during an actual laparoscopic procedure is inadvertent since there is a disconnect between how much force the user is exerting on the proximal end of the laparoscopic device and how much of the user exerted force is actually transmitted to the distal end of the laparoscopic device to the tissue and/or organ.

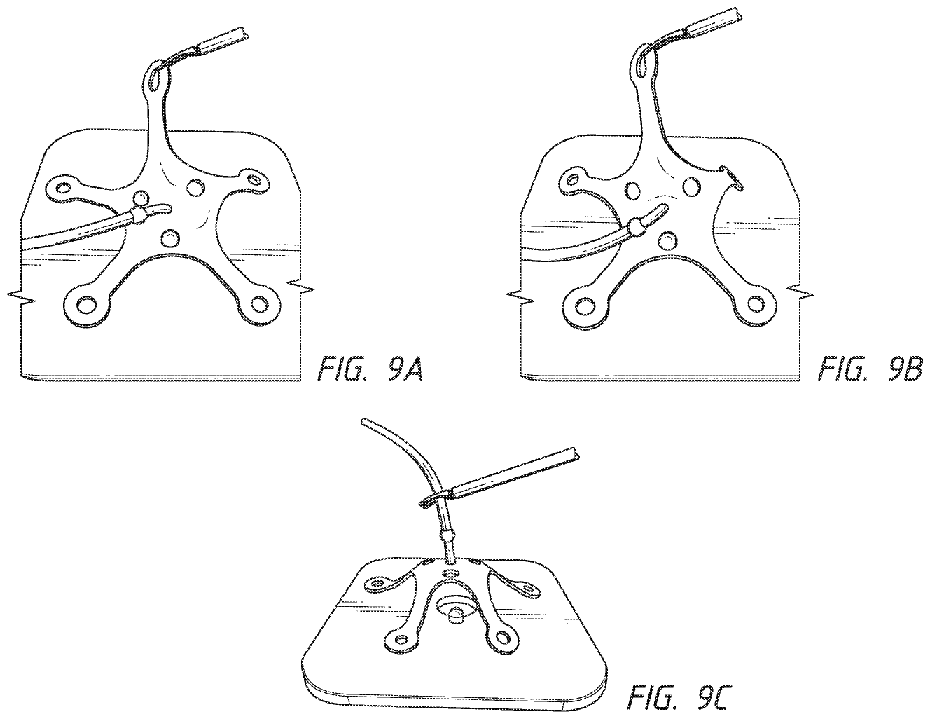

FIG. 9A-FIG. 9C illustrate embodiments of the force perception mechanism in use with the multiskill exercise model 100. In particular, each of the figures illustrate scenarios where a force greater than what is allowed via the pre-defined force threshold associated with the force perception mechanism is provided by the user via the laparoscopic devices. In each of the cases, a portion of the body 110 becomes detached/disengaged from the one or more pegs 130 that are used to implement the force perception mechanism with the multiskill exercise model 100. The figures illustrate exemplary embodiments where the body 110 has become disengaged from one (see. FIG. 9A), two (see FIG. 9B) or all (see FIG. 9C) of the pegs 130 implemented with the multiskill exercise model 100. Furthermore, the user is shown to be exerting force on different portions of the multiskill exercise model 100, for example, a limb (in FIG. 9A and FIG. 9B) as well as the post 120 (in FIG. 9C).

In various embodiments, the amount of force that is allowed, tested, evaluated, or assessed (i.e., the pre-determined force threshold) is modifiable between different versions of the multiskill exercise model 100. For example, by changing the size and shape of the pegs 130, the materials which the body 110, the pegs 130, and/or base 140 are made of, as well as the type of connection (e.g., degree of fit) between the pegs 130 with the body 110, the pre-determined force threshold can be adjusted which in turn affects how much force a user can exert on the multiskill exercise model 100 before the body 110 becomes detached from one or more of the pegs 130. In addition, embodiments have been contemplated where the arrangement of the pegs 130 may allow for user application of force in one direction to have a higher pre-determined force threshold compared to other directions.

When the body 110 becomes detached/disengaged from at least one peg 130, this occurrence is used as a visual indicator for the user that an excessive amount of force was applied to the multiskill exercise model 100 by the user via the laparoscopic devices. In various embodiments, this indicator can be used to notify the user that the laparoscopic training task has failed. In some embodiments, requirements may indicate that failure of the laparoscopic training task corresponds with the detachment/disengagement of the body 110 from two or more pegs 130. In some embodiments, requirements may indicate that failure of the laparoscopic training task corresponds with the detachment/disengagement of the body 110 from a specific one or more pegs 130. In this way, the force perception mechanism is configured to train the user on how to control the amount of force being applied by the laparoscopic devices. The force perception mechanism can also be used to train the user with how much force is allowed during a laparoscopic procedure by providing feedback (e.g., visual) as to when too much force has been applied based on when the body 110 becomes detached from the pegs during the performance of laparoscopic training task. If the user provides too much force during the actual laparoscopic procedure, the tissue being operated on may experience trauma. Additional discussion related to the force perception mechanism and other embodiments are provided in the co-pending application “Force Perception Mechanism for Physical Laparoscopic Simulation Models”, the entire disclosure of which is hereby incorporated by reference as if set forth in full herein.

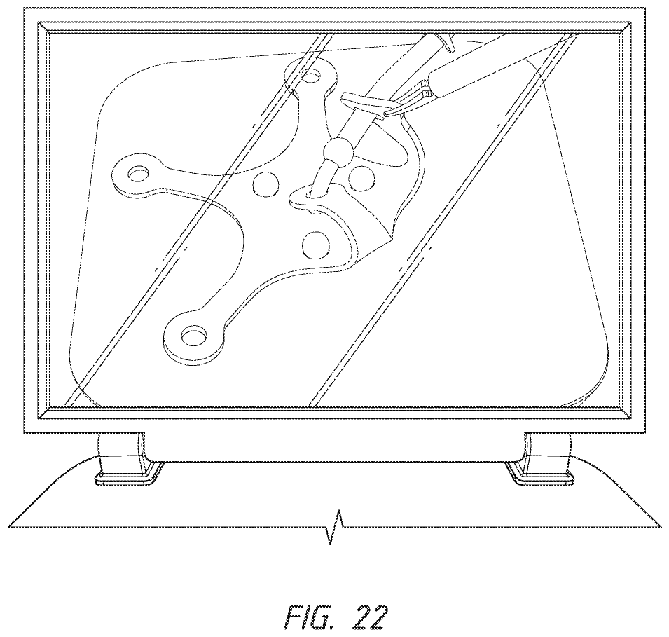

The motor and cognitive skills being developed via the multiskill exercise model 100 are useful due to the nature of laparoscopic procedures. For example, an exemplary motor and cognitive skill being developed may include hand-eye coordination which would allow the user to adapt to the challenging process of relying on indirect visualization of the area of interest undergoing laparoscopic surgery obtained from imaging devices (e.g., laparoscopes, endoscopes or cameras) and performing the surgical procedure relying on the indirect visualization when used in connection with a surgical trainer. In particular, reference to the indirect visuals are those visuals that are obtained using image capturing devices internal to the surgical trainer (or a patient in an actual laparoscopic procedure) and displayed for the user to view on a display screen (see FIG. 22). In various embodiments, the display screen may be associated with the surgical trainer although other embodiments may have display screens that are separate from the surgical trainer.

Another example of motor and cognitive skills being developed via the multiskill exercise model 100 is depth perception. Because laparoscopic procedures are performed using indirect visuals that are two-dimensional in nature, depth perception is a necessary skill which allows users to determine how far objects are away from the distal ends of the surgical instruments being used in a three-dimensional space while relying on a two-dimensional image of that same space.

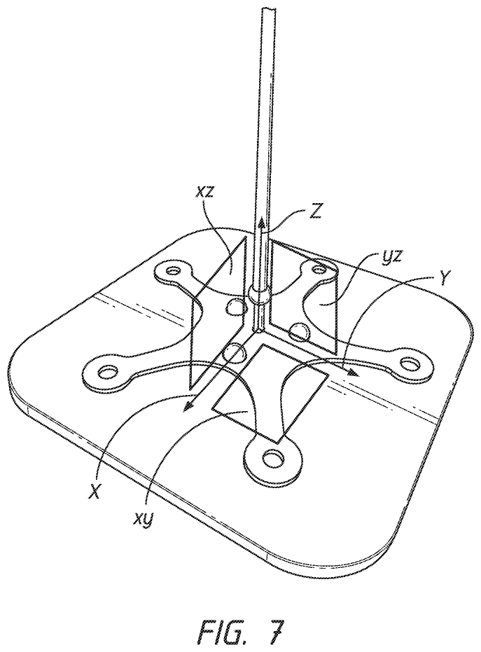

Generally, the user is required to make spatial determination when performing laparoscopic procedures in the three-dimensional space using the two-dimensional visual input provided by image capturing devices within the same three-dimensional space. However, the visual input can come from one or more planes (e.g., xz, yz, and xy) relative to their respective axis (e.g., x, y, and z) which may not all be accurately captured as a two-dimensional visual input. An exemplary illustration of the various planes is provided in FIG. 7.

In an example scenario, when the laparoscopic camera comes from the x-direction, the position of objects or features located in the same x-coordinate or the yz plane (or any number of planes parallel with the yz plane) can be easily perceived. The user does not need to analyze new sensory information to drive motion between objects within the same x-coordinate, the yz plane, or planes parallel to the yz plane. However, when the x-coordinate becomes variable, depth perception can become more challenging as it may be more difficult to determine the distance of an object from the focal point of the laparoscopic device. Furthermore, it may be difficult to maneuver the instruments with respect to objects/features in the three-dimensional space using only the two-dimensional visualization (e.g., the display screen). To assist in the training of the depth perception skill, the multiskill exercise model 100 uses the axisymmetric properties associated with the limbs so that each of the limbs can be located at a different axial position. In this manner, the user can be trained to move laparoscopic devices in the principal planes (e.g., xy, xz, yz-planes) as well as planes different from the principal planes allowing the user to gauge and interpret the laparoscopic device movements in the three-dimensional space all while viewing those same movements on the two-dimensional visualization.

In addition, with the multiskill exercise model 100 employing axial symmetry with respect to the symmetry axis as illustrated in FIG. 2 or the z-axis as illustrated in FIG. 7, the multiskill exercise model 100 can also employ planar symmetry with respect to the xz plane (as illustrated in FIG. 7) as well. Thus, in various embodiments, the laparoscopic training tasks performed on the right side of the multiskill exercise model 100 (with respect to the limb and the post 120) will have a symmetric counterpart where the roles of the instruments being used are reversed (e.g., the roles associated with the user's hands are swapped). This facilitates the user's development of bimanual dexterity. Furthermore, the multiskill exercise model 100 is made to be agnostic to a user's hand dominance.

It should be noted that the above features of the multiskill exercise model 100 being axisymmetric and/or planar symmetric may be present in various embodiments. However, in various embodiments, a particular multiskill exercise model 100 may not have both axial and planar symmetry. For example, embodiments are contemplated where a multiskill exercise model 100 utilizes limbs of varying lengths, limbs with different amounts of openings, different spacing between the openings of the limbs, a non-linear post, and/or various combinations thereof. Each of these embodiments being contemplated are embodiments where the body can be axisymmetric but may not be planar symmetric and vice versa.

As noted earlier, to simulate laparoscopic surgery, the multiskill exercise model 100 may be compatible with surgical trainers. The surgical trainers simulate laparoscopic procedures by obstructing the user's vision of the multiskill exercise model 100 and instead have the user rely on one or more sources of indirect visualization (e.g., image capture of the model displayed on a display screen). An exemplary surgical trainer can be seen, for example, in FIG. 21. Exemplary embodiments illustrating one or more different multiskill exercise models 100 inside the surgical trainer can be seen, for example, in FIG. 23.

The multiskill exercise model 100 may be mechanically anchored or otherwise connected (e.g., adhered) to the surgical trainer via its base 140. The connection between the base 140 of the multiskill exercise model 100 and the surgical trainer allows for the multiskill exercise model 100 to remain stationary while the user manipulates portions of the multiskill exercise model 100 (e.g., the body 110 and/or the post 120). In some embodiments, the base 140 may not be used. Rather, the surgical trainer may be directly connected/attached to at least a portion of the body 110 and/or the post 120 of the multiskill exercise model 100. In some embodiments, the surgical trainer may house two or more different multiskill exercise models 100.

Referring back to FIG. 9A-FIG. 9C, the force perception mechanism is present in the exemplary multiskill exercise model 100 to train users to adapt to and visualize an amount of force being exerted during performance of a laparoscopic training task. The body 110 is configured to disengage from the pegs 130 if an amount of force exerted on the overall model or portions thereof (e.g., the limbs and/or post 120) exceeds a pre-determined force threshold. The pre-determined threshold amount of force can be customized based on the type of connection (e.g., interference fit) being present between the pegs 130 and the body 110. For example, by changing the shape and/or size of the pegs or the materials in which the pegs and/or the body 110 are made of, the body 110 can be made to be easier or harder to disengage from the pegs 130. The change in the ease of the body 110 in disengaging from a peg 130 corresponds to a change in the associated pre-determined force threshold (and the allowable forces usable with the multiskill exercise model).

In various embodiments, the number and the types of structures used to implement the force perception mechanism are designed to detect forces exerted on the multiskill exercise model 100. In an embodiment, an exemplary force can be detected via the multiskill exercise model 100 when the limb and/or post 120 are pulled on by the user via the laparoscopic devices. Furthermore, when portions of the limb and/or post 120 become stretched, a tension force used to stretch the body 110 and/or post 120 may be transferred to the pegs 130. In response to the tension force, a reactionary friction force will be produced at the pegs 130. The reactionary friction force provides a resistance for the body 110 from becoming disengaged from the pegs 130. However, the body 110 can become disengaged from the pegs 130 if the tension force transferred to the pegs 130 exceeds the existing friction force produced between the body 110 and the peg 130. The force that is exerted on the multiskill exercise model 100 and subsequently transferred to one or more pegs 130 can differ based on the location of where the exerted force originates (e.g., pulling the post 120 or pulling a limb of the body 110) which in turn can translate to different amounts and types of forces being exerted onto the multiskill exercise model 100. Accordingly, the different types of forces can affect how the body 110 becomes disengaged from one or more pegs 130.

Aside from managing the amount of force being applied to the multiskill exercise model 100, other features are also implemented to develop a user's motor and cognitive skills for laparoscopic surgery. In particular, other variations to the multiskill exercise model 100 are also contemplated and described herein. These additional embodiments of the multiskill exercise model provide variations in the shape, size, and/or arrangement of one or more features (e.g., body, post, base) that can in turn affect how the laparoscopic training task can be performed by the user as well as affect how the user's motor and cognitive skills are developed for laparoscopic surgery.

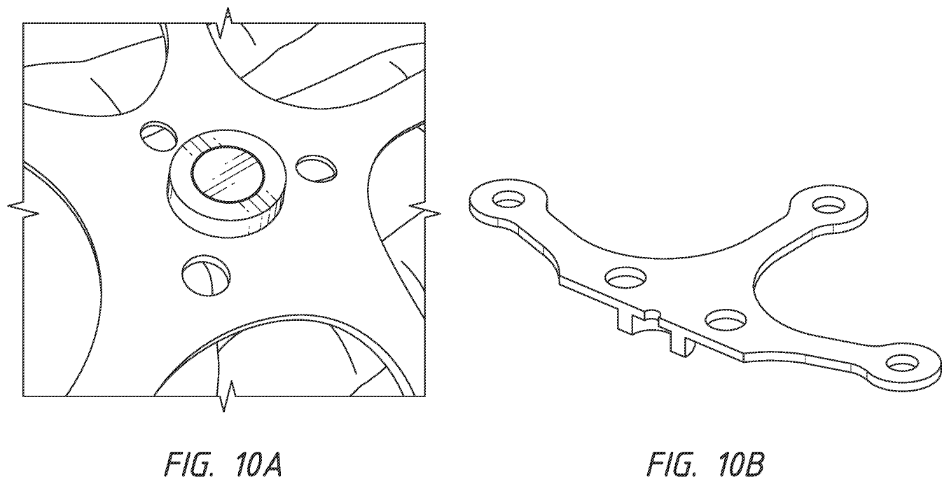

In some embodiments, the body 110 may have additional support structures to provide additional support for the post 120. The additional support structures may be located around an axis of symmetry and/or associated with the opening in the body 110 where the post is connected. Exemplary support structures can be seen, for example, in FIG. 10A and FIG. 10B. For example, FIG. 10A and FIG. 10B illustrate support structures and materials that have been incorporated (e.g., molded) to the body 110 near the axis of symmetry. In some embodiments, the support structures may be manufactured separately from the body 110 and afterwards attached to the body 110 to provide support.

The support structures may be configured to act as reinforcement for the body 110 preventing damage to the portions of the body 110 where the post 120 comes into contact with the body 110 or when an excessive amount of force is exerted on the body 110 and/or post 120. For example, the support structures can be configured to distribute user exerted force more evenly on the body 110 and/or post 120 thereby affecting two or more different pegs 130. The distribution of the user exerted force allows for an increase in an overall amount of allowable force on the body 110 and/or post 120 before the body 110 becomes detached from one or more peg. Furthermore, the support structure may also include an area (e.g., indented space) which can be used to secure the post 120 to the body 110 using, for example, adhesives (as illustrated in FIG. 10A).

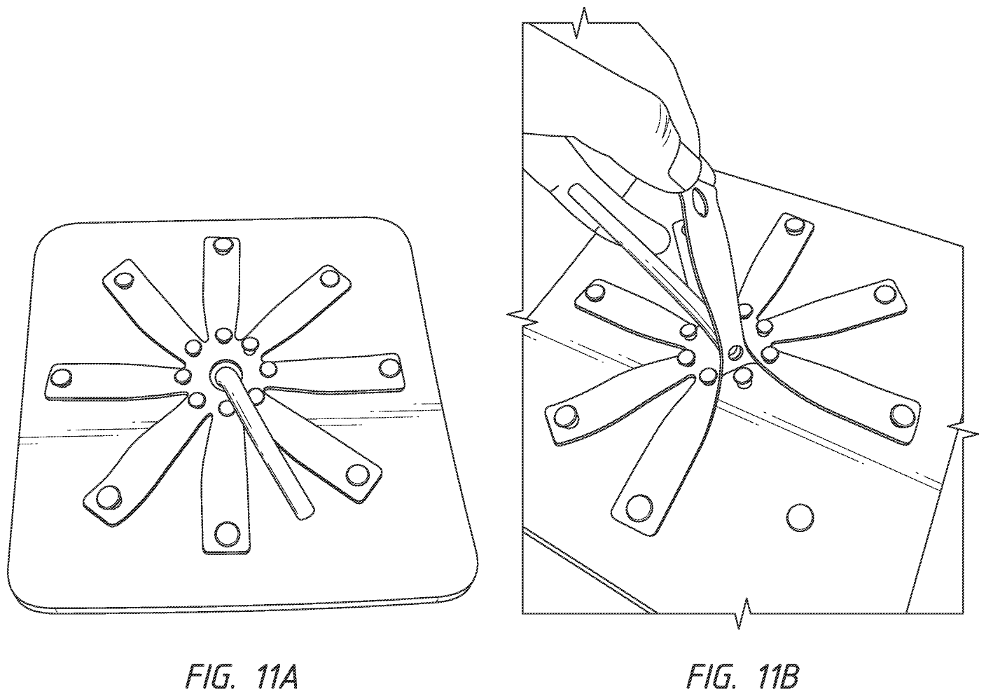

FIG. 11A and FIG. 11B illustrates another embodiment of a multiskill exercise model 100. In the exemplary multiskill exercise model 100 (as illustrated in FIG. 11A), the model has a body 110 comprising a number of limbs extending away from a center of the model, a post 120 located at the center of the model, a number of pegs 130 used to implement the force perception mechanism, and a base 140. Although the multiskill exercise model 100 illustrated in FIG. 11 shares many similar features of the earlier multiskill exercise model 100 discussed above (e.g., illustrated FIG. 1), the variations present an example of how changes can affect the laparoscopic training task being performed by the user. For example, the body 110 of the multiskill exercise model 100 illustrated in FIG. 11A and FIG. 11B comprises a plurality of limbs each with two separate openings (one opening at the distal end of the limb away from the post and one at the proximal end of the limb near the post). The proximal opening may be configured to receive a first peg while the distal opening may be configured to receive a second peg. The second peg may be provided so that the limbs can be held stationary until the user selects a specific limb to perform a laparoscopic training task. In various embodiments, the second peg could also be used for purposes of identifying an amount of force being applied to the limb. Meanwhile, the first peg would be used in connection with the force perception mechanism to monitor an amount of force being applied to that limb during performance of the laparoscopic training task. In some embodiments, performance of the laparoscopic training task may direct the user to also avoid causing nearby limbs from detaching from their respective pegs interfacing with their proximal openings. In other embodiments the limbs may have more than two openings spaced along the limb between the distal end and the proximal end of the limb so that more than two pegs may used (e.g., additional pegs can be placed in between the proximal and distal ends of the limb).

In various embodiments, a pre-determined force threshold is required to detach a portion the body (e.g., limb) from the associated peg. In various embodiments, the pre-determined force threshold required to detach the limb from a peg at the proximal end of the limb may be different from pegs located elsewhere on the same limb or even other limbs. For example, in one embodiment, the pre-determined threshold of force required to detach the limb from the peg at the distal end of the limb may be less than the pre-determined threshold of force required to detach the limb from the peg at the proximal end of the limb. As such, various embodiments may utilize structures such as pegs having different shapes, sizes, arrangements, and/or compositions located at the distal end of the limbs and the proximal end of the limbs, or vice versa or any combination thereof to provide for the different force thresholds.

With respect to FIG. 11B, the limb is configured to be detachable from the peg located at the distal end of the limb (as illustrated in FIG. 11A). Furthermore, the limb is also capable of being detached from the pegs located at the proximal end of the limb. In various embodiments, the user may be instructed (in the performance of an exemplary laparoscopic training task) to exert enough force to remove the limb from the set of pegs located at the distal end and navigate the distal end of the limb (with the now exposed opening) towards the post without detaching the limb from the other set of pegs located at the proximal end of the limb.

In one embodiment, when there are two or more pegs along the length of the limb located between the proximal and distal ends of the limb, an exemplary laparoscopic training task may require the user to only detach the distal most peg (i.e., the peg farthest from the post). Afterwards, the user may be directed to navigate the post through the distal most opening of the limb without detaching the limb from any of the other pegs associated with the same limb, else the laparoscopic training task being performed may be deemed a failure. In other embodiments, the user may be able to remove the limb from all the pegs associated with a particular limb but may not be allowed to exert any force that would cause the other limbs to detach from their respective pegs.

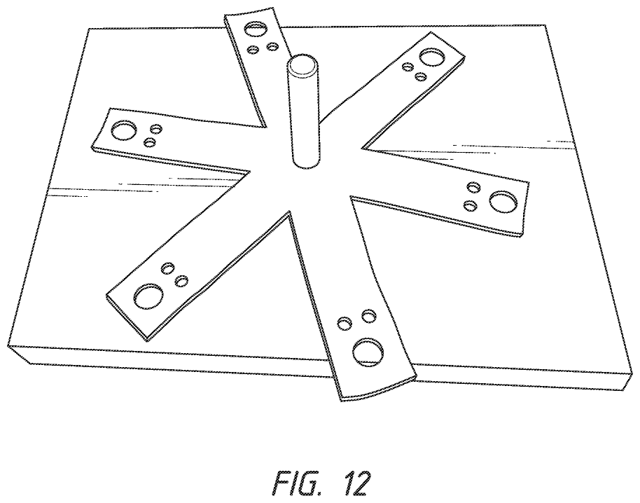

FIG. 12 illustrates another embodiment of a multiskill exercise model. In this embodiment, the post is a rigid material that may not be capable of being stretched, flexed, or otherwise manipulated via the use of a laparoscopic device. For example, the rigid post may be made of a solid (e.g., metal) rod. In various embodiments, the rigid post may be made of a hollow (e.g., metal) rod. The exemplary multiskill exercise model illustrated in FIG. 12 does not have force perception mechanism implemented. However, in various embodiments, a force perception mechanism may be implemented in connection with one or more of the limbs as described in various embodiment above.

With the embodiment illustrated in FIG. 12, an exemplary laparoscopic training task may instruct the user to navigate one of the openings at the distal end of the limb to the post. The openings associated with each of the limbs may vary in size corresponding, for example, with associated pegs and/or with the post. In various embodiments, additional openings can be provided which can facilitate with the grabbing and maneuvering of the limbs with the laparoscopic devices. Since the rigid post cannot be manipulated (e.g., bent, flexed), the user may be directed to use one hand or instrument to move one of the limbs to the post in order to complete the laparoscopic training task. In some embodiments, a user may be instructed to use both hands to maneuver two different limbs simultaneously with respect to the rigid post.

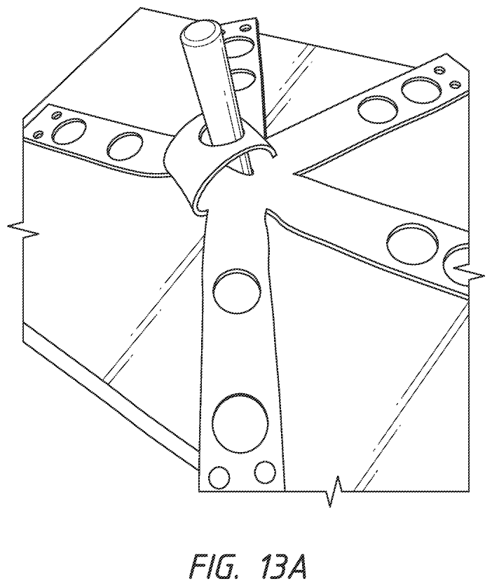

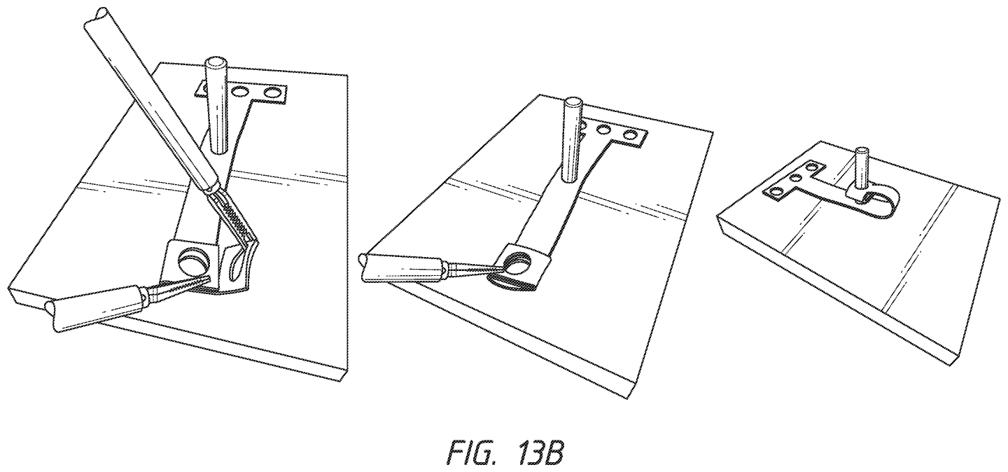

FIG. 13A and FIG. 13B illustrate various other embodiments of a multiskill exercise model. In particular, the limbs of the illustrated multiskill exercise models have multiple openings associated with each of the limbs. These multiple openings may be positioned at pre-determined locations along the length of the limb (as illustrated in FIG. 13A) and/or aligned with the distal end of the limb via adjacent tabs (as illustrated in FIG. 13B). One particular laparoscopic training task for the multiskill exercise models of FIG. 13A and FIG. 13B is to have the user align the multiple openings for the same limb so that all the openings form one consolidated opening. The consolidation of the openings may require the users to bend and fold the limb onto itself so that two separate openings align using one or both hands. After all the openings of the same limb have been aligned, the user can then navigate the post (using one or both hands) through the consolidated openings.

Although the post (as illustrated in FIG. 13A and FIG. 13B) is a rigid post, other various embodiments are also possible with features that are similar to those described above. For example, the multiskill exercise model illustrated in FIG. 13A and FIG. 13B, in some variations, may have a post that can be flexible or is at least less rigid (e.g., made of an elastic or flexible material). In various embodiments, the rigid post may be capable of being deformed or, in some embodiments, be biased to return (e.g., spring) to a rest state (e.g., extending straight from the base). These alternative variations to the rigid post can provide additional challenges with how the user would need to maneuver the consolidated opening and/or the post in order to complete a laparoscopic training task.

The variations in the embodiments illustrated in FIG. 13A and FIG. 13B can be configured to develop the user's simultaneous use of both hands to use both laparoscopic devices to hold and manipulate the limbs so that the multiple openings associated with a limb can be aligned. Furthermore, both hands may still be needed to maintain the consolidated state of the multiple openings while positioning the rigid post through the consolidated opening.

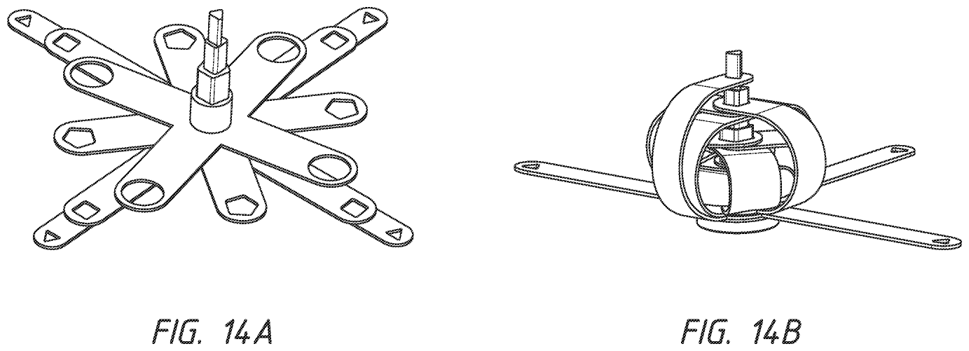

FIG. 14A and FIG. 14B illustrate another embodiment of a multiskill exercise model. In various embodiments, the post can be made of a rigid material, although other embodiments of this variation and others may have a semi-rigid or flexible post. At least with reference to the embodiment illustrated in FIG. 14A, the post has a number of different tiers located along the length of the rigid post. The tiers may be established on the rigid post at pre-determined intervals equal distance from each other. At each tier, the rigid post may have a different cross-sectional shape and (e.g., triangle, square, pentagon, circle) which is configured to match with one or more openings associated with the limbs of the body. Furthermore, each of the tiers, as they progress from the bottom to the top of the post, the size of the cross-sectional shape decreases which dictates an order for the limbs to be aligned with the post.

With continued reference to FIG. 14A, in various embodiments, there are a corresponding number of bodies comprising a number of separate limbs. The bodies may be separate and layered on top of each other. In some embodiments, the limbs (each having the different cross-sectional shape and/or sized opening) may all be connected as a single body.

With respect to the embodiments of the separate and layered bodies, at the center of each of the bodies is an opening which allows the rigid post to connect with each of the bodies. Each of these limbs has a distal opening having a cross-sectional shape and/or size that corresponds to one of the cross-sectional shapes and/or size of the rigid post. For example, if the rigid post has 4 tiers each having a different cross-sectional shape and size, there will be four bodies with each body having a different set of limbs each having a distal opening that corresponds to one of the cross-sectional shape and size of one of the four tiers associated with the post. In some embodiments the separate layer can have one or more limbs that have distal openings that do not share the same cross-sectional shape and size. Furthermore, in various embodiments, the limbs that share the same cross-sectional shape and size can be color-coded the same color. In some embodiments, each of the separate bodies can be made of different materials to facilitate in differentiating the different layers; other embodiments may have each of the bodies be made of the same material.

With reference to FIG. 14B, an exemplary laparoscopic training task associated with this embodiment of the multiskill exercise model may involve the user inserting the distal opening of the various limbs to the corresponding tier on the rigid post. The user would be directed to identify the limb(s) with the distal opening that corresponds with the cross-sectional shape and size of the lowest tier on the rigid post. The user can then use one or both hands to maneuver one or two limbs simultaneously using laparoscopic devices to have their openings align with the rigid post. Subsequently the user would navigate the opening of each limb down the post until it coincides with the matching cross-sectional shape of the tier being worked on. Once all the limbs for the lowest tier have been identified and threaded onto the rigid post, the user can then proceed with the next higher tier of the rigid post, identifying, maneuvering and aligning the set of limbs that match with the cross-sectional shape and size of the next higher tier.

In some embodiments, the bodies may be arranged (e.g., layered) in the order that the limbs would be threaded onto the rigid post. As illustrated in FIG. 14B, the topmost base layer may correspond to the lowest tier on the rigid post while the bottom most body layer may correspond to the highest tier on the rigid post. In other embodiments, the bodies may be arranged in an order that is different from the order of the tiers associated with the rigid post. In some embodiments, the different limbs having the various different cross-sectional shapes can all be connected as a single body. Furthermore, in various embodiments, the one or more bodies may be rotatable around the rigid post thereby requiring the user to orient the opening of each of the limbs with the rigid post.

FIG. 15 illustrates another embodiment of a multiskill exercise model. In this multiskill exercise model, the post has various irregular shapes that protrude at different orientations along the length of the post. These irregular shapes form a cross-sectional shape for the post at varying sections along the length of the post. The cross-sectional shapes correspond to the shape of the distal openings of each of the limbs of the body but in a different orientation.

With respect to the limbs, they are located at the bottom of the post. The limbs are connected to the post in a way that allows the limbs to be capable of rotating around the rigid post. For example, each of the limbs may have an opening that is configured to receive the post. The post can then be secured with a base, or in some embodiments, with the bottom-most limb such that the post is not capable of being removed. The latter connection maintains the former connection between the post and each of the limbs.

As illustrated in FIG. 15, each of the limbs may be separate from one another and/or layered on top of each other at the central location near the post. However, in various embodiments, two or more limbs may be connected as a singular body which would still be rotatable around the post. The post, in various embodiments, is more rigid than one or more of the limbs and/or, in various embodiments, the one or more limbs are bendable while the post is not or resists flexing or bending.

During performance of the laparoscopic training task, the user will be directed to navigate and thread the opening of a limb onto the post by bending and flexing the limb. Next, the user would need to rotate the limb accordingly so that the opening of the particular limb aligns with the irregular shapes protruding on the post so that the limb is able to clear each level and be maneuvered further down along the post. As such, the limb is then rotated to different locations around the post so that the orientations of the opening can be made to clear the next irregular shape (and so forth) further down the post.

In various embodiments, the limbs and/or bodies may be stationary in nature with a post that is rotatable at the center of the limbs and/or bodies. In a variation of the laparoscopic training task, the user may be directed to orient the opening of the limb with the post and rotate the post so that the opening of the limb can clear each of the irregular shapes of the post as the limb travels down the length of the post.

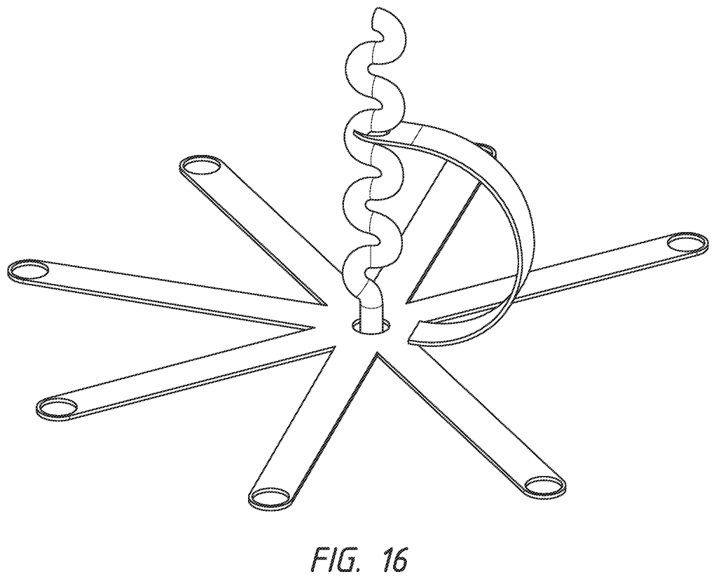

FIG. 16 illustrates another embodiment of a multiskill exercise model. In this multiskill exercise model, the post may have a non-linear shape. As illustrated in the figure, the the post may have a wave-like profile. At the bottom of the post is a body that comprises a number of limbs each having a distal opening. The body may be rotatable around the rigid post. In some embodiments, the post may be rotatable with respect to the body (which would be stationary). In various embodiments, the limbs may be separate from each other and/or layered one on top of another yet still rotatable around the post. The post, in various embodiments, is more rigid than one or more of the limbs and/or, in various embodiments, the one or more limbs are bendable while the post is not or resists flexing or bending.

In performing the laparoscopic training task, the user will be directed to maneuver the distal opening of each limb of the body along the post. This may require the user to use one or both laparoscopic devices to bend/flex the limb in order to have the limb travel down the post. In some instances, the user may need to adjust the orientation of the limb in order to re-align the opening of the limb with the post in order to progress the limb down the length of the post. In some variations, the user may be required to rotate the post and/or the limb or body in order to progress the opening of the limb down the post.

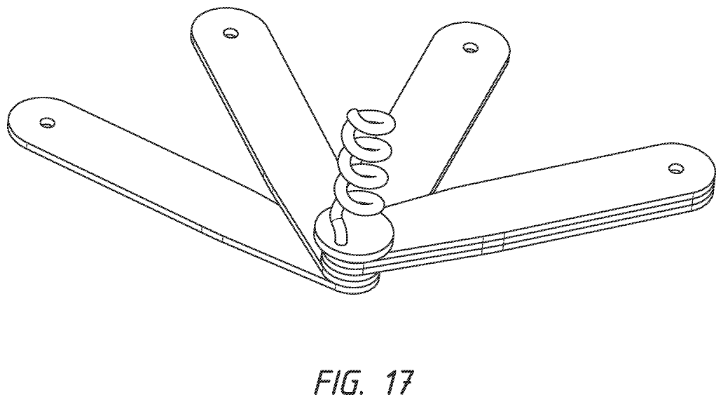

FIG. 17 illustrates another embodiment of a multiskill exercise model. In this multiskill exercise model, the post has a helical shape. In addition, the multiskill exercise model comprises a number of limbs which are stacked below the post. The post can connect each of the limbs together with the post thereby allowing the limbs to be rotatable around the post. In some embodiments, the limbs may each be connected to each other to form a single body. The post, in various embodiments, is more rigid than one or more of the limbs and/or, in various embodiments, the one or more limbs are bendable while the post is not or resists flexing or bending.

Similar to FIG. 16, the user (in performing an exemplary laparoscopic training task) will be directed to thread each opening of the limbs along the helical post by adjusting the orientation of the opening via bending, flexing and/or rotating the limb. In addition, the user can also adjust the orientation of the limb via rotation of the limbs with respect to the post so as to allow the opening of the limb to travel down the length of the post.

In some embodiments, the limbs can be made to be stationary and instead have the post be rotatable. Thus, the laparoscopic training task would direct the user to rotate the post in order to have the opening of the limb travel down the length of the post. In various embodiments, the one or more limbs and the post are rotatable.

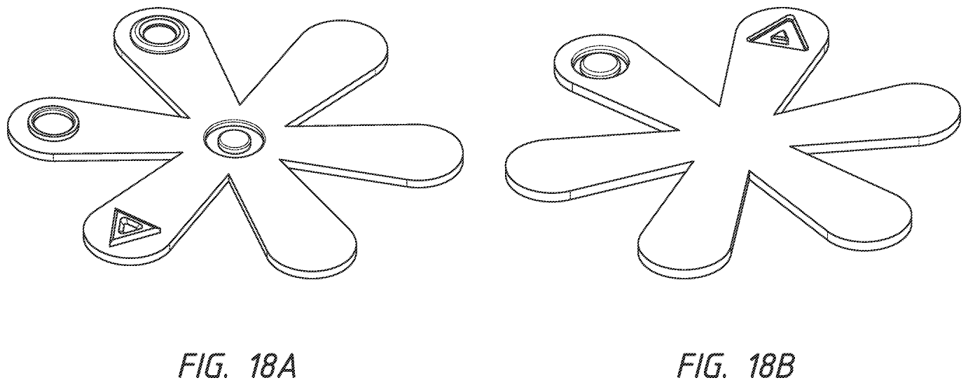

FIG. 18A and FIG. 18B illustrate another embodiment of a multiskill exercise model. In this embodiment, the multiskill exercise model comprises a generally planar body having a number of limbs extending away from the center. In various embodiments, the multi-exercise model does not include a post nor are there any openings at the distal end of the limbs as in the above embodiments. Rather, each of the distal ends of the limbs have a snap mechanism incorporated or attached therein. Furthermore, at the center of the multiskill exercise model, a snap mechanism counterpart is provided that corresponds with at least one of the snap mechanisms of one of the limbs. In some embodiments, each of the snap mechanisms may be manufactured as a separate piece and embedded within or otherwise connected with each of the limbs. In some embodiments, the snap mechanisms may be formed (e.g., molded) as one piece along with the body. In some embodiments, each of the limbs may be separate from each other.

In some embodiments, each of the limbs may have a snap mechanism (e.g., male part) that is capable of snapping with a female snap mechanism counterpart at the center of the model (e.g., female counterpart). The user, in performing the laparoscopic training task, is directed to maneuver one of the distal ends of the limb (via bending, folding the limb) in order to snap the male part of the mechanism at the end of the limb to the female part in the center of the multiskill exercise model. Afterwards, the user would be directed to remove the limb currently snapped to the center of the model so that another limb can then be selected and snapped to the center.

In some embodiments, the distal ends of each of the limbs can have a predetermined number of different shapes. The center of the multiskill exercise model will have one female snap mechanism that is configured to connect with one the corresponding shape of at least one of the distal ends of the limbs. The user, in performing the laparoscopic training task, would need to identify which distal end has the snap mechanism with a matching shape as the shape of the one in the center of the multiskill exercise and move that distal end of that limb to snap connect with the center snap mechanism counterpart.

In addition, in various embodiments, the underside of each of the limbs of the multiskill exercise model (as illustrated in FIG. 18B) can have additional female snap mechanism that would correspond to one or more of the male snap mechanisms of the other limbs. These female snap mechanisms on the underside of the limbs would act as additional snap mechanism counterparts similar to the one at the center of the multiskill exercise model. By using this arrangement of counterparts on the underside of the limbs, as the users snap the limb to the center of the multiskill exercise, the underside of that limb is exposed revealing the additional female snap mechanism. The users can then be directed to identify the next limb to interact and move to snap to the center of the multiskill exercise model. Thus, the limbs can each be snapped one on top of another via the snap mechanisms found in the center of the model as well as on both sides of the limbs.

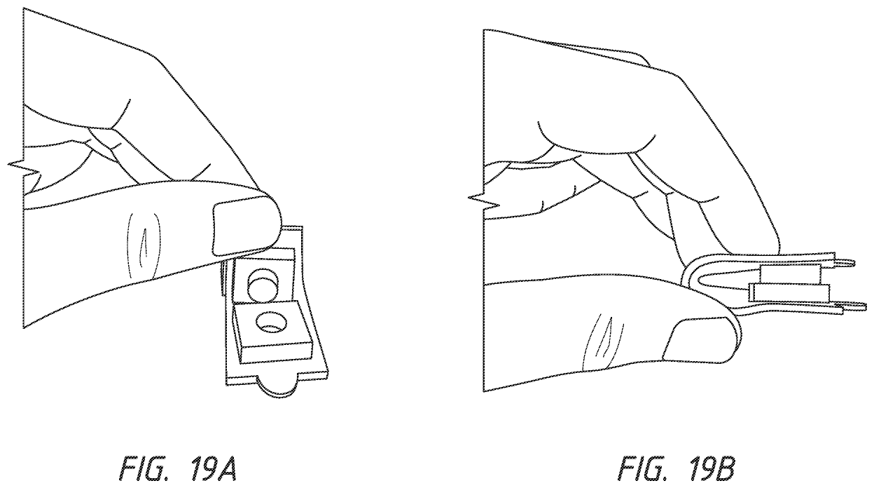

FIG. 19A and FIG. 19B illustrate another embodiment of the snap mechanism. The snap mechanism (as illustrated in FIG. 19A) would have a male and female counterpart. For example, the male part of the snap mechanism may comprise a snap base having a structure (e.g., a peg) that extends from the snap base. In contrast, the female counter may comprise a base with an opening that is configured to receive the structure of the male part.

The structure for the male part may have any number of different cross-sectional shapes. For example, the cross-sectional shapes can be non-circular (e.g., square, star, triangle). The female counterpart will have an opening that corresponds to the cross-sectional shape for the male part. When snapped together, the structure (e.g., peg) for the male part may be completely received by the female counterpart such that the snap base of both the male part and female counterpart are adjacent to one another. In various embodiments, the structure for the male part may be longer than the width of the snap base of the female counterpart and/or the depth of the opening of the female counterpart, in which case, the snap base of the male part and the female counterpart may be spaced apart at least based on the difference between the size of the structure and the width of the snape base and/or depth of the opening associated with the female counterpart.

FIG. 20 illustrates another embodiment of a multiskill exercise model. In this multiskill exercise model, the model comprises a body having limbs that extend away from the center of the model. Furthermore, at the center of the model, is a post. The post has a singular non-circular cross-sectional shape. However, at varying locations along the length of the post, the non-circular cross-sectional shape has varying orientations thus providing the post with a non-uniform shape along the length of the post. The limbs associated with the body of the multiskill exercise model have at least one opening at the distal end of the limbs with the same non-circular cross-sectional shape as the post.

In various embodiments, the limbs may be separate from each other (i.e., are separate bodies) but are layered beneath one another such that they are all connected to the rigid post. Furthermore, the individual limbs may be rotatable with respect to the post. The post, in various embodiments, is more rigid than one or more of the limbs and/or, in various embodiments, the one or more limbs are bendable while the post is not or resists flexing or bending.

In performing the laparoscopic training task, the user will be directed at maneuvering one of the distal ends of the limb down the post. To do so, the user will move the opening to the post (via bending/flexing the limb). To maneuver the limb down the length of the post, the user will be directed to rotate the post (with the body being stationary) thereby allowing the opening of the limb to clear each of the non-circular cross sections and travel down the length of the post. In other embodiments, the user may be directed to rotate the body with respect to the post being stationary to allow the opening of the limb to clear successive cross sections of the post. In other embodiments, the user may be directed to rotate both the body and the post to allow the opening of a limb to clear successive cross sections of the post.

FIG. 21 is an example embodiment of a surgical trainer. The surgical trainer 2100 is designed for practicing laparoscopic or other minimally invasive surgical procedures. In particular, the surgical trainer 2100 can be designed to mimic a torso or abdominal region of a patient.

The surgical trainer 2100 includes a body cavity 2105 that is substantially obscured from the user via, for example, the top cover 2115. The body cavity 2105 is configured to receive simulated or live tissue or model organs or training models. As applicable for this present disclosure, the body cavity 2105 would be adapted to receive any one of the above described multiskilled exercise models (as illustrated in FIGS. 1-20) or any combinations thereof. For example, FIG. 23 illustrates an example embodiment where the surgical trainer has one multiskill exercise model housed within the body cavity 2105. It should be noted that more than one multiskill exercise model may be housed within the body cavity 2105 in various embodiments.

The body cavity 2105 is accessible via one or more pre-established apertures 2130 located in the top cover 2115. The pre-established apertures 2130 are configured to receive one or more laparoscopic devices (e.g., graspers, dissectors) being used by the user for the practice of surgical techniques (e.g., laparoscopic surgery) on the tissue or practice model (e.g., multiskill exercise model) located in the body cavity 2105. Although the body cavity 2105 is shown to be accessible through the pre-established apertures 2130, other means of accessing the body cavity 2105 may also be provided. For example, a hand-assisted access device or single-site port system can also be used with the surgical trainer 2100 in order to access the body cavity 2105.

The surgical trainer 2100 includes a top cover 2115 that is connected to and spaced apart from a base 2120 by at least one leg 2125. In some embodiments, for example such as the one illustrated in FIG. 21, the surgical trainer 2100 may have multiple legs 2125. As mentioned above, in an embodiment, the surgical 2100 is configured to simulate laparoscopic conditions. The top cover 2115 can be made to be representative of an anterior surface of the patient and the space between the top cover 2115 and the base 2120 is representative of an interior of the patient or the body cavity 2105 where organs would generally reside. As such, the surgical trainer 2100 is a useful tool for teaching, practicing, and demonstrating various surgical procedures and their related instruments in simulation of a patient undergoing a surgical (e.g., laparoscopic) procedure.

In some embodiments, the base 2120 can include a model-receiving area 2135 or tray. The model-receiving area 2135 or tray is designed for staging or holding a simulated tissue model or live tissue as well as other practice models such as the multiskill exercise models described herein. To help retain a model on the base 2120, a retractable wire can be attached to the model and a clip. The clip can then be attached to the base 2120 at various locations 2140 within the surgical trainer 2100. The retractable wire is extended and clipped to hold the model in position substantially beneath the pre-established apertures 2130. Other means for retaining a model (e.g., tissue, live, practicing) include a patch of hook-and-loop type fastening material (VELCRO®) affixed to the base 2120 in the model receiving area 2135 such that it is removably connectable to a complementary piece of hook-and-loop type fastening material (VELCRO®) affixed to the model.

In some embodiments, a video display monitor 2145 can be provided that is hinged to the top cover 2115. The video display monitor 2145 is shown in a closed orientation in FIG. 21. In contrast, an exemplary embodiment of the video display monitor 2145 in an open orientation can be seen in FIG. 22. The video monitor 2145 is connectable to a variety of visual systems for delivering an image to the video monitor 2145. For example, a laparoscope inserted through one of the pre-established apertures 2130 or a webcam located in the body cavity 2105 (used to observe the simulated procedure) can be connected to the video monitor 2145 and/or a mobile computing device (not shown) to provide an image to the user. Also, audio recording or delivery means may also be provided and integrated with the surgical trainer 2100 to provide audio and visual capabilities. Means for connecting a portable memory storage device such as a flash drive, smart phone, digital audio or video player, or other digital mobile device is also provided, to record training procedures and/or play back pre-recorded videos on the monitor for demonstration purposes. The connection means for providing an audio-visual output to a screen larger than the video monitor 2145 is also possible and can be provided for the surgical trainer 2100 in various embodiments. In another embodiment, the top cover 2115 may not include the video monitor 2145 but may instead contain features that allow for the connection of the surgical trainer 2100 with a laptop computer, a mobile digital device or tablet where the audio visual output can be viewed. The connection features can be wired and/or wireless.

When assembled, the top cover 2115 is positioned directly above the base 2120 with the legs 2125 located substantially around the periphery and interconnected between the top cover 2115 and the base 2120. The top cover 2115 and the base 2120 are substantially the same shape and size and have substantially the same peripheral outline. The internal cavity 2105 is partially or entirely obscured from view. In an embodiment (as illustrated in FIG. 21), the legs 2125 may include openings to allow ambient light to illuminate the internal cavity 2105 as much as possible. Furthermore, the openings of the legs 2125 may also advantageously provide weight reduction for the surgical trainer 2100 as possible for convenient portability. In some embodiments, the top cover 2115 is removable from the legs 2125 which in turn are removable or collapsible via hinges or the like with respect to the base 2120. This allows the unassembled trainer 2100 to have a reduced height that provides for easier portability.

In summary, the surgical trainer 2100 provides a simulated body cavity 2105 that is obscured from the user. The body cavity 2105 is configured to receive at least one surgical model (e.g., multiskill exercise model) accessible via at least one aperture 2130 in the top cover 2115. In this way, the user may access the models housed within the surgical trainer 2100 in a manner that can be used to practice laparoscopic or endoscopic minimally invasive surgical techniques. Further exemplary surgical trainers are also described in U.S. patent application Ser. No. 13/248,449 entitled “Portable Laparoscopic Trainer” filed on Sep. 29, 2011 and U.S. patent application Ser. No. 15/895,707 entitled “Laparoscopic Training System” filed on Feb. 13, 2018, both of which are incorporated herein by reference in their entirety.

In accordance with various embodiments, the surgical training systems described herein include a model that is configured to facilitate in the training and development of motor and cognitive skills that would be useful in the practice of laparoscopic surgery. The present disclosure describes various embodiments which each contain variations to one or more of the body, post, structures used to implement the force perception mechanism, and/or base which offer different features for the model which users can interact with when performing laparoscopic training tasks with the model.

In accordance with various embodiments, the multiskill exercise model comprises one or more posts, bodies, structures implementing a force perception mechanism, bases, or any combination thereof. In various embodiments, one or more posts may be an elongate tube. In various embodiments, one or more posts, bodies or any combination thereof may be made of an elastomeric material. In various embodiments, one or more posts, bodies or any combination thereof may be made of silicone and in various embodiments, may be made of the same material. In various embodiments, one or more posts, bodies or any combination thereof are stretchable, flexible and/or bendable. In various embodiments, one or more posts has a proximal portion that is fixed relative to one or more bodies and/or bases and a distal portion that is bendable relative to the one or more bodies and/or bases. In various embodiments, one or more posts has a proximal portion that extends away from one or more bodies and/or bases and a distal portion that curves back towards the one or more bodies and/or bases. In various embodiments, one or more posts are more rigid than the one or more bodies, not bendable, made of a material less flexible than the one or more bodies or any combination thereof. In various embodiments, one or more posts or portions thereof may be curved, straight, helical and/or follow a non-linear path.

One or more bodies, in various embodiments, comprise one or more limbs. In various embodiments, a body comprises a center portion from which one or more limbs extend. In various embodiments, one or more posts have a length that is longer than one or more limbs of the body. In various embodiments, one or more posts are stretchable to a length that is longer than one or more limbs of the body. In various embodiments, the one or more posts, limbs and/or any combination thereof are bendable and/or movable to contact and/or interact with each other. In various embodiments, the one or more posts have a thickness or define a cross-section that is greater than a thickness or cross-section of the one or more bodies. In various embodiments, one or more bodies and/or limbs are movable and/or rotatable relative to a post. In various embodiments, one or more bodies are stackable and/or positionable over one another. In various embodiments, one or more bodies are sized, shaped and/or oriented differently from each other. In various embodiments, one or more limbs of one or more bodies are shorter than other limbs of other bodies.

In various embodiments, the force perception mechanism comprises one or more pegs. In various embodiments, one or more pegs are cylindrical and in various embodiments have hemispherical or beveled tops. In various embodiments, one or more pegs are connected and/or connectable to one or more bases of the model and/or trainer. In various embodiments, one or more pegs are elongate and have a length or height smaller than the one or more posts. In various embodiments, the one or more pegs has a thickness and/or height that is greater than a thickness or height of the one or more bodies.

In various embodiments, one or more bodies comprises one or more apertures or openings. In various embodiments, the one or more openings are connected and/or connectable to one or more posts and/or pegs. In various embodiments, one or more openings in one or more center portions and/or one or more limbs of one or more bodies are connected and/or connectable to one or more pegs and/or one or more posts. In various embodiments, one or more openings of one or more bodies have an interference fit with one or more posts and/or pegs. In various embodiments, one or more openings of one or more limbs can be aligned over each other. In various embodiments, one or more limbs are foldable over themselves.

In various embodiments, one or more limbs comprise one or more protrusions and/or recesses. In various embodiments, one or more center portions of one or more bodies comprises one or more protrusions and/or recesses that are correspondingly connectable to one or more protrusions and/or recesses of the one or more limbs. In various embodiments, one or more protrusions and/or recesses of one or more limbs are correspondingly connectable to one or more protrusions and/or recesses of the same limb. In various embodiments, one or more limbs comprise one or more protrusions and/or recesses on an upper surface and/or a lower surface of the one or more limbs. In various embodiments, one or more protrusions and/or recesses on an upper surface of one or more limbs are correspondingly connectable to one or more protrusions and/or recesses of a lower surface of another of one or more limbs.

In various embodiments, a post extends and/or is extendable along an axis with one or more limbs of the one or more bodies extending along one or more axes that are traverse to the axis in which the post extends. In various embodiments, a post extends and/or is extendable along an axis orthogonal to an axis along which one or more limbs extend. In various embodiments, a post extends and/or is extendable along a symmetry axis with one or more limbs of one or more bodies arranged symmetrically around the axis of symmetry. In various embodiments, a base extends along a plane that is parallel to a plane in which one or more limbs extend.

In various embodiments, one or more posts have one or more slots or protrusions disposed along its length. In various embodiments, one or more openings of one or more limbs are able to be threaded through or pulled over one or more slots or protrusions of one or more posts. In various embodiments, one or more openings of one or more limbs are removably connectable to one or more slots or protrusions of one or more posts. In various embodiments, one or more slots or protrusions disposed along one or more posts have differing shapes, sizes, orientations, or any combination thereof relative to each other. In various embodiments, one or more openings of one or more bodies have differing shapes, sizes, orientations, or any combination thereof relative to each other. In various embodiments, one or more openings of one or more bodies are shaped, sized and/or oriented to correspondingly match one or more slots or protrusions of one or more posts.

In various embodiments, a base is made of a material more rigid than the one or more posts, bodies, or any combination thereof. In various embodiments, one or more bases are made of plastic and/or are made of the same material as one or more pegs. In various embodiments, one or more bases are sized and/or shaped to fit within a surgical trainer. In various embodiments, a multiskill exercise model is sized and/or shaped to fit within a surgical trainer. In various embodiments, one or more bases and/or bodies comprise surface features arranged to prevent or reduce adherence or stickiness and/or facilitate movement of portions of one or more bodies away from a base and/or each other. In various embodiments, an anti-stick coating or layer is attached or integrated into the one or more bases and/or bodies. In various embodiments, an anti-stick layer is separately provided and positioned between a base and body.

In various embodiments, the model comprises a body, a post, a plurality of pegs used to implement a force perception mechanism, and a base. In some embodiments, one or both of the body and/or the base may be planar. The body is configured to be flexible and can be made of an elastic material. Furthermore, the body comprises a plurality of limbs extending from a center of the body each having at least one opening at a distal end of the limbs. Additional openings along the length of the limbs are also provided in other embodiments. The openings associated with the limbs and/or located at the center of the body are configured to interface with the plurality of pegs and/or the post. As such, the openings facilitate the establishment of removable connections between the body and the base via the pegs. A post is positioned at the center (e.g., axisymmetric) location of the body. The post may be rigid or flexible. In some embodiments, a flexible post can be stretchable. Furthermore, the flexible post may be biased towards a pre-determined location. The post may also include features, such as obstacles or extrusions, which direct the user to orient the opening at the distal ends of the limbs in order to clear and maneuver the structure down the length of the post. The pegs, which are connected to the base, interface with the body through the plurality of openings near the center of the body and are configured to have a pre-determined force threshold. When the user exerts force on the model (via the body and/or the post), the body around one or more of the pegs may disengage when the exerted force exceeds the pre-determined force threshold. The base can attach the model to a surgical trainer whereby the body rests on top of the base and is removably connected via the pegs. In some embodiments, however, the base may be omittable from the model.

In various embodiments of the model, a stretchable body comprises an opening at the center that is configured to receive the post. The stretchable body also comprises a plurality of limbs that extend away from the post. Each of the limbs comprises two openings, wherein one opening is located at the distal end of the limb and the other opening is located at the proximal end of the limb. Each of the two openings associated with the limbs are configured to interface with pegs. In other embodiments, the limbs may comprise more than two openings that are each configured to receive additional pegs. The post in this embodiment of the model may be flexible or rigid. The body may rest on a base. The base may be connected to each of the pegs. In another embodiment, the base may be omitted.

In various embodiments of the model, a stretchable body comprises an opening at the center that is configured to interface with a rigid post. The stretchable body also comprises a plurality of limbs that extend away from the post. Each of the limbs comprises a plurality of openings located at the distal end of the limb, wherein a first group of openings are configured to interface with pegs and a second group of openings are configured to interface with the rigid post, and wherein the size of the first group of openings and the second group of openings is different. In some embodiments the size of the openings is the same thus allowing each opening to interface with both the pegs and the rigid post.

In various embodiments of the model, a stretchable body comprises an opening at the center that is configured to interface with a rigid post. The stretchable body also comprises a plurality of limbs that extend away from the post. Each of the limbs comprises a plurality of openings along the length of the limb going from the proximal end near the post to the distal end away from the post. In some embodiments, the openings along the limbs are spaced evenly from each other and are configured to allow the user to flex/fold the body so that the openings can be placed one on top of another to form a consolidated opening. In some embodiments, the limbs may also include a second group of openings located at the distal end of the limb that are capable of interfacing with pegs. The size of the second group of openings is different from that of the openings along the length of the limb that are configured to interface with the post. In another embodiment, the limb may further include tabs or extensions to the body that are located at the distal end of the structure and perpendicular to the length of the limb. The tabs further include openings that are configured to be overlapped with the other openings associated with the length of the limb prior to interfacing with the post.

In various embodiments, the model comprises a plurality of layers of bodies, wherein each body comprises a plurality of limbs. In some embodiments, the different bodies are color coded. Each limb of the same body has a pre-determined geometric shaped opening and the limbs of different bodies have different pre-determined geometric shapes from one another. At the center of the bodies is a rigid post having a plurality of tiers. At each different tier, a cross section of the post has the same shape as one of the pre-determined geometric shapes associated with the openings of the limbs of a body. In some embodiments, the order of the bodies being layered below the post (from top to bottom) corresponds to an inverse order (from bottom to top) of the tiers associated with the post.

In various embodiments, the model comprises a plurality of bodies layered beneath and connected with a post. The plurality of bodies comprises limbs that extend away from the post and are rotatable around the post. At the distal end of each limb is an opening, with each of the openings sharing the same geometric shape. The post comprises a plurality of protrusions at pre-determined locations along the length of the post. At each of the pre-determined locations along the length of the post, the post and the protrusions form a cross section that is similar to the geometric shape of the openings associated with the limbs. However, each of the protrusions along the length of the post have a different orientation from one another thereby directing a user to rotate the limb such that the opening at the distal end of the limb aligns with the protrusion of the post as the limb is pulled down the length of the post.

In various embodiments, a model comprises a body and a non-linear post. The body comprises a plurality of limbs that extend away from the non-linear post each having an opening at the distal end of the limb. The post, having a non-linear shape, comprises a combination of vertical, horizontal, and curved sub-sections. The non-linear shape of the post directs a user to orient the opening at the distal end of the limb so that the limb is able to travel along the length of the post.

In various embodiments, a model comprises a plurality of bodies layered beneath a non-linear post. The plurality of bodies comprises separate limbs which extend away from the non-linear post and are rotatable around the non-linear post. Furthermore, each of structures has an opening at the distal end of the limb that is configured to interface with the non-linear post. The non-linear post has a helical shape which directs the user to orient the opening at the distal end of the limb and rotate the limb around the non-linear post in order to maneuver the limb along the length of the non-linear post.

In various embodiments, a model comprises a flexible body. The flexible body comprises a plurality of limbs that extend away from the center of the model. At the center of the model is a snap mechanism counterpart that is configured to snap fit with one or more of the snap mechanisms found at the end of each of the limbs of the body. In some embodiments, each of the limbs may have snap mechanisms each having a different geometric shape. The snap mechanism counterpart located at the center of the model is configured to have a shape that matches one of the shapes of the snap mechanisms at the distal end of the limbs. In some embodiments, each of the limbs may also have a snap mechanism counterpart having a geometric shape on an opposite (e.g., bottom) surface of the snap mechanism located on a top surface of the body. The snap mechanism counterpart on the opposite surface of one limb is configured to snap fit with a matching snap mechanism on the top surface of the body of a different limb that shares the same shape.

In various embodiments, a model comprises a flexible body. The flexible body comprises a plurality of limbs that extend away from the center of the model. At the end of each of the limbs is an opening having a geometric, non-circular shape. At the center of the model is a post. The post is rotatable while the body is stationary. In some embodiments, the post may be stationary with the body rotatable around the post. The post has a plurality of sections each having a cross-sectional shape that is the same as the opening of the limbs. However, each adjacent section on the post is in a different orientation. As such, the post directs the user to rotate the post as one of the limbs is maneuvered down the post in order to have the opening clear each section of the post.

In various embodiments, a surgical trainer can be provided which is configured to simulate a torso or abdominal region of a patient during laparoscopic surgery. The surgical trainer comprises a top, bottom, and a plurality of legs which forms the enclosure or body cavity. The user's direct vision of any models housed within the surgical trainer is obstructed thereby requiring the user to rely on indirect images obtained via, for example, cameras internal to the surgical trainer and which are displayed on a display screen outside of the surgical trainer. The surgical trainer is configured to house one or more different models (as described above) within the body cavity. The surgical trainer is configured to allow one or more laparoscopic devices into the surgical trainer through the top cover, for example, at pre-determined locations or through apertures set within the top cover.

Although the present invention has been described in certain specific aspects, many additional modifications and variations would be apparent to those skilled in the art. It is therefore to be understood that the present invention may be practiced otherwise than specifically described, including various changes in the size, shape, and materials, without departing from the scope and spirit of the present invention. For example, one of ordinary skill in the art should be able to use the examples to derive a variety of different implementations which retain the main functionalities of the surgical training systems described throughout the present disclosure. Although some of the embodiments utilize descriptions which are specific to structural and/or method-related steps, it is to be understood that such subject matter are not necessarily limited to the specifics (e.g., functionality for a feature can be distributed differently over more than one component or be performed in a combination of components different from what was identified explicitly above). Thus, embodiments of the present invention should be considered in all respects as illustrative and not restrictive.

The above description is also provided to enable any person skilled in the art to make and use the devices or systems and perform the methods described herein and sets forth the best modes contemplated by the inventors of carrying out their inventions. Various modifications, however, will remain apparent to those skilled in the art. It is contemplated that these modifications are within the scope of the present disclosure. Different embodiments or aspects of such embodiments may be shown in various figures and described throughout the specification. However, it should be noted that although shown or described separately each embodiment and aspects thereof may be combined with one or more of the other embodiments and aspects thereof unless expressly stated otherwise. It is merely for easing readability of the specification that each combination is not expressly set forth.

1. A surgical training model comprising:
a body having one or more holes at pre-determined locations; and
a post having a proximal end and a distal end, wherein the proximal end is attached to the body, and wherein the post extends away from the body,
wherein the body is configured to be manipulated to thread the distal end of the post through one of the one or more holes.

2. The surgical training model of claim 1, wherein the post is rigid.

3. The surgical training model of claim 1, wherein a cross-section of the post is non-circular, and wherein the one or more holes has a shape corresponding to the cross-section of the post.

4. The surgical training model of claim 1, wherein the post is flexible and is configured to be manipulated alongside the body to thread the distal end of the post through one of the one or more holes.

5. The surgical training model of claim 1, wherein the post further comprises a protrusion near the proximal end, and wherein the body is configured to be maneuvered down a length of the post past the protrusion.

6. The surgical training model of claim 1, wherein the body comprises a plurality of limbs.

7. The surgical training model of claim 1, wherein the body is removably attached to a base at one or more pre-determined locations, and wherein detachment of the body from the base at the one or more pre-determined locations informs a user that a force that is more than a pre-determined amount is been detected during the manipulation of the body and/or the post.

8. The surgical training model of claim 7, wherein the body has holes that are configured to removably attach the base to the body at the one or more pre-determined locations via pegs associated with the base.

9. The surgical training model of claim 1 further comprising a surgical trainer, wherein the surgical trainer is configured to house the surgical training model within an internal cavity.

10. The surgical training model of claim 1, wherein the body has two or more holes and wherein the body is configured to be manipulated positioning the two or more holes to form a consolidated opening prior to the post being threaded through the consolidated opening.

11. A surgical training model comprising
a plurality of limbs having a proximal end and a distal end, wherein each of the plurality of limbs are layered on top of one another at their proximal ends, and wherein each of the plurality of limbs have one or more holes; and
a post having a proximal end and a distal end, wherein the proximal end is attached to the proximal ends of the plurality of limbs, wherein the post extends away from the plurality of limbs,
wherein each of the plurality of limbs is configured to be manipulated to thread the distal end of the post through their respective holes.

12. The surgical training model of claim 11, wherein each of the one or more holes of the plurality of limbs has a pre-determined shape and size.

13. The surgical training model of claim 11, wherein a diameter of the post decreases from its proximal end to its distal end.

14. The surgical training model of claim 11, wherein the post comprises a pre-determined number of sub-sections each having a different cross-sectional shape and size.

15. The surgical training model of claim 14, wherein at least one of the one or more holes of the plurality of limbs corresponds to the cross-sectional shape and size of one of the sub-sections of the post.

16. The surgical training model of claim 11, wherein the post has a plurality of protrusions having different cross-sectional shapes along a length of the post.

17. The surgical training model of claim 16, wherein the one or more holes has a pre-determined shape and size corresponding to the cross-sectional shapes formed by the plurality of protrusions on the post, and wherein the plurality of limbs are rotatable with respect to the post to align the one or more holes with the cross-sectional shapes formed by the plurality of protrusions as limb is maneuvered along the length of the post.

18. The surgical training model of claim 11, wherein the post has a non-linear profile along a length of the post.

19. The surgical training model of claim 18, wherein the post has a wave-like profile or a helical profile.

20. The surgical training model of claim 11, wherein the plurality of limbs are rotatable with the post or proximal end of each of the plurality of limbs being at a center axis.
